(19) United States
(12) Patent Application Publication
(10) Pub. No.: US 2025/0050751 A1
(43) Pub. Date: Feb. 13, 2025

(54) CHARGING DEVICE FOR BATTERIES

(71) Applicant: Nyobolt Limited, Cambridge Cambs (GB)

(72) Inventors: Sai Shivareddy, Cambridge (GB); Steve Hutchins, Cambridge (GB); Mahesh De Silva, Cambridge (GB); Iain Mosely, Oxford (GB)

(21) Appl. No.: 18/720,086

(22) PCT Filed: Dec. 16, 2022
(86) PCT No.: PCT/EP2022/086510

§ 371 Date: Jun. 14, 2024

(30) Foreign Application Priority Data
Dec. 17, 2021 (GB) 2118428.8
Feb. 11, 2022 (GB) 2201822.0

(51) Int. Cl. B60L 53/10; B60L 53/53; B60L 53/62

(52) U.S. Cl. CPC B60L 53/11; B60L 53/53; B60L 53/62; B60L 2210/10

(57) ABSTRACT

The invention relates to a battery-to-battery charging device, method of charging and use of the charging device. The method comprises steps of discharging a battery to a power connector using a charging engine, wherein a receiver battery is separably connectable to the power connector, sending data on the condition of the battery to a controller, and adjusting the discharge rate of the battery to increase the discharge rate, wherein the discharge rate is increased to a rate of 3C or more. The device can be used for providing fast battery-to-battery charging, in particular from a portable battery to a larger receiver battery (for example an electric vehicle or uninterrupted power supply battery).

### RELATED APPLICATIONS

This application claims priority to, and the benefit of, GB 2118428.8 filed on 17 Dec. 2021 (17.12.21) and GB 2201822.0 filed on 11 Feb. 2022 (11.02.22), the contents of both of which are hereby incorporated by reference in their entirety.

### TECHNICAL FIELD

The invention relates to a charging device, method of charging and uses of the charging device.

### BACKGROUND

One of the problems with the use of battery-powered devices is the time required for charging. The batteries required for large scale applications, such as in industrial equipment, electric vehicles (EVs), uninterrupted power supplies (UPSs), as well as personal electronic devices such as smartphones or laptop computers, may require several hours to charge, limiting their usefulness. Furthermore, charging may be required at a time that is not convenient, because the battery powered device needs to be used or because a power supply is not available.

Another problem with the use of batteries, especially in large scale applications such as in industrial equipment, electric vehicles (EVs), uninterrupted power supplies (UPSs), is uncertainty over how long the battery will power the device. For example, the capacity of the batteries used to operate an EV is limited, variable dependent on conditions and usage, and therefore difficult to predict.

For personal electronic devices, there is also uncertainty over how long the battery of the device will last, especially when carrying out video and telephone conversations. Also, the use of battery-powered devices to carry out important tasks such as filling in online forms the contents of which will not be saved in case of an interruption of power also carries increased risk where there is a danger of the device losing charge and powering down before the user can save their work.

The risk of depleting a battery is increased by a lack of power supply availability. For example, in large scale applications such as industrial equipment or EVs the availability of electricity may be limited due to use in remote locations. In particular, the number of EV charging stations is relatively low, especially compared to the high number of petrol stations. These disadvantages reduce the uptake of EVs, especially for long journeys, and prolongs the use of petrol-driven cars with known detrimental effects on the environment.

In particular, in emergency situations where mains power supplies are not available, such as on the side of a road, there is a need for charging systems which can provide rapid and high rate of charging. Equally, it is desirable if the charging system can be quickly recharged from a power supply, so that it can be reused again quickly.

There are a limited number of known systems which can add a small amount of charge to a receiver battery, such as the battery of an EV. These systems provide slow charging of the receiver battery.

One example of such a system is the Blink® portable charger. This is a small petrol-powered generator. The Blink® portable charger supports 240 V charging only, using AC current, and provides a maximum power output of about 9.6 kW. The Blink® portable charger does not provide fast charging. The time taken for charging is significant and limits the real-world usability of the charger. The Blink portable charger also relies on a petrol generator, and therefore is polluting and releases fumes that may make it dangerous to use in an enclosed space such as a covered car park or garage. The Blink portable charger is also bulky, with a volume of 635 litres, and heavy, weighing 160 kg. This makes the Blink® charger difficult to transport and use.

Another example of a known emergency charger system is the Sparkcharge® Roadie. This is a modular battery pack system which due to its size and bulk can only reasonably be carried by a dedicated vehicle such as a breakdown assistance van. The charger provides 150-500 V charging, using DC current and provides a maximum power output of 20 kW. Each battery module has a capacity of 3.5 kWh. The Sparkcharge® Roadie requires an extremely long charging time. Typically, the system can only be used once per day and must then be charged overnight. This reduces the useable time of the device.

A further example of an existing moveable charger system is the ZipCharge Go®. This is a portable battery system which is able to charge at a power of 7.2 kW. The system also includes a management system including an AC-DC inverter. The ZipCharge Go® has limited capacity and can only add up to 32 km of range to an EV over approximately 30 minutes.

Accordingly, there is a need for charging devices which can provide improved charging rates to a receiver battery, improved capacity and energy density, and can be quickly recharged.

### SUMMARY OF THE INVENTION

Generally, the invention relates to a method of charging a receiver battery from a charging device. The charging device includes a battery having high discharge rate capabilities, and other components which enable the battery to discharge at the fastest possible rate. The method of charging includes steps of discharging the battery to a power connector, while the other components of the device monitor data on the condition of the battery to determine if the charging rate can be increased. In other words, if the data indicates the battery is performing well or in an acceptable condition, the discharge rate can be increased. However, if the discharge rate is increased to such a level that the data shows the battery is performing poorly or is in a bad condition, then the discharge rate can be maintained or decreased. This method, along with the high discharge rate capabilities of the battery, enable fast discharging of the battery, and in turn a high rate charging of a receiver battery (e.g. in a receiver device, such as an EV).

In a first aspect there is provided a method of charging a receiver battery from a charging device, the charging device comprising:
a battery, wherein the battery comprises an electrochemical cell,
a power connector, in separable electrical connection with the receiver battery,
a charging engine, in electrical communication with the battery and the power output,
and
a controller, in communication with the battery and the charging engine, and the method comprising the steps of:
discharging the battery to the power connector, using the charging engine,
sending data on the condition of the battery to the controller, and
adjusting the discharge rate of the battery to increase the discharge rate, wherein the discharge rate is increased to a rate of 3C or more, in response to the data.

In some embodiments, the battery comprises an electrochemical cell having a working electrode active material comprising a niobium-containing metal oxide.

In a second aspect there is provided a charging device, for charging a receiver battery, the charging device comprising:
a battery, wherein the battery comprises an electrochemical cell;
a power connector, to separably electrically connect to the receiver battery;
a charging engine in electrical communication with the battery and the power connector, wherein the charging engine controls the rate of discharge of the battery; and
a controller in communication with the battery and the charging engine, for adjusting the discharging rate of the battery in response to data on the condition of the battery, to increase the discharge rate, wherein the discharge rate is increased to a rate of 3C or more.

In some embodiments, the battery comprises an electrochemical cell having a working electrode active material comprising a niobium-containing metal oxide.

In a third aspect there is provided a use of the device of the second aspect for charging an electric vehicle, an uninterrupted power supply or a mobile computing device.

Fast charging is usually only possible using large, high total capacity batteries. Smaller, lower total capacity batteries would normally not be sufficient to charge a receiver device at the maximum charging rate it could accept, and so only slow charging is possible.

Unexpectedly, the charging device and method of the invention allows for charging of a battery of an EV or other receiver device at an extremely high rate. This is possible even from a battery that is small enough to be portable and which may have a lower capacity than the receiver battery. The charging device also ensures that the high discharge rate is safe (e.g. avoids overheating) and does not adversely affect the capacity retention or life span of the battery of the charging device, by monitoring data on the condition of the battery and controlling the charging rate accordingly.

This device and method enable increased reliability for using an EV for long journeys and therefore an EV's real-world utility. Similarly, it increases the reliability of other battery-powered receiver devices by potentially allowing the user to charge the battery enough to finish a task in progress. It also allows the portable battery in question to be recharged extremely quickly, increasing the usefulness of a charging device carried by, for example, a breakdown assistance van, where it could also be recharged directly from the engine.

The high charge and discharge rate of the charging device is possible due to a combination of the electrochemical properties of the cells that make up the battery and the circuitry comprising the controller and charging engine. The chemistry of the battery facilitates a high rate of discharge, while the controller and charging engine allow this high rate of discharge to be optimized during discharge by monitoring the condition of the battery, so the maximum discharge rate can be achieved for the conditions.

In particular, the controller and charging engine associated with the battery may be optimised for maximum efficiency and thermal management. This may, for example, involve a controller which receives voltage, current, and temperature information and optimises the charging and discharging rate to be as fast as possible while remaining within a safe temperature range.

The controller may also control appropriate active or passive cell balancing in the battery, to improve the safety of rapid charging and discharging. By balancing cells during charging and discharging, the device avoids an overvoltage or undervoltage of any individual cell, which can cause damage to the cells. This balancing may occur during rapid charging and discharging, which is important because the voltage of each cell is constantly changing. This differs from conventional systems which only perform cell balancing while the battery is not in use, which reduces the utility and discharge rate.

The controller and charging engine may also be physically arranged to optimise the use of space within a small casing and to allow optimal thermal management, for example by the use of air channels, fans, and thermally conductive materials.

In a first embodiment there is provided a method of charging, a charging device and a charging system, where the discharge rate of the battery in the charging device is lower than the charge rate of the receiver battery.

In the context of the first embodiment, the discharge rate of the battery in the charging device may be referred to as the first C-rate, and the charge rate of the receiver battery may be referred to as the second C-rate.

The first embodiment generally provides battery-to-battery charging method and device which takes advantage of modern fast-charging battery technology to provide rapid charging at convenient times. This improves the usefulness of battery-powered devices and allows users to take advantage of the availability of renewable energy sources and off-peak energy tariffs.

In the first embodiment, the battery of the charger device typically has a larger total capacity than the receiver battery.

In a second embodiment there is provided a method of charging, a charging device and a use of the charging device, where the discharge rate of the battery of the charging device is higher than the charge rate of the receiver battery.

In the context of the second embodiment, the method and device are convenient to use as a relatively small battery of the charging device may be used to charge a larger receiver battery. The problem solved is how to charge a big battery as fast as possible when access to the grid is not possible and it is not desirable to transport around a much larger spare battery, which would usually be needed to provide the high rate of charging.

In the second embodiment, the battery of the charger device typically has a smaller total capacity than the receiver battery.

The terms “charger” may be used interchangeably with “charging device”, and “receiver” may be used interchangeably with “receiver device”

### BRIEF DESCRIPTION OF THE FIGURES

FIG. 1 shows a schematic of the system of the first embodiment. FIG. 1a shows a charging device connected to a receiver device, and FIG. 1b shows a charger device connected to a carrier and further to a receiver device.

FIG. 2 shows a schematic block diagram of a controller of the system of the first embodiment.

FIG. 3a shows a schematic block diagram of the charging engine and system controller of the Charging system of the first embodiment. FIG. 3b shows a schematic block diagram of the power conditioning system, battery management system, and internal battery of the charging device of the first embodiment.

FIG. 4 shows a flowchart showing the process of connection and charging of the charging device and receiver of the first embodiment.

FIG. 5 shows a schematic diagram of the charging device of the second embodiment, including a charging device connected to a receiver device and the charging device optionally connected to mains electricity. FIG. 5a shows a charging device where the receiver device is an electric vehicle. FIG. 5b shows a system where the receiver device is an uninterrupted power supply. FIG. 5c shows a system where the receiver device is a mobile computing device.

FIG. 6a shows a block diagram of an example charger of the system of the second embodiment. FIG. 6b shows a block diagram of an example charging device of the second embodiment, including the controller and charging engine of the charging device.

FIG. 7 shows example embodiments of charging device of the second embodiment. FIG. 7a shows a charging device mounted on a mobile vehicle. FIG. 7b shows a handheld charging device. FIG. 7c shows a USB charging device.

FIG. 8 shows a flowchart showing the process of connection and charging and discharging of the charging device of the second embodiment.

FIG. 9 shows a graph of the state of charge of a charging device of the second embodiment compared to a conventional charging device, when charging the battery of an EV. The graph shows state of charge (%) over time (s).

FIG. 10 shows a simplified block diagram of an additional embodiment of the charging device of the invention.

FIG. 11 shows a simulation of the change in charge over time for the charging device shown in FIG. 10 (upper line), compared to a conventional charging device including a conventional battery (lower line). The graph shows accumulated charge (Ah) over time (s).

### DETAlLED DESCRIPTION OF THE INVENTION

In a first embodiment of the invention there is provided a charging system comprising a charger comprising a first storage device including a plurality of battery cells operable to discharge at a first C-rate, and a Receiver comprising a second storage device including a second plurality of battery cells, wherein the Receiver is operably coupled to the charger and is operable to be charged at a second C-rate by the charger, wherein the second C-rate is equal to or greater than the first C-rate, wherein at least one of the first plurality or the second plurality of battery cells comprises a working electrode active material comprising a metal oxide.

The rate may be any suitable measurement of charge or discharge rate, such as power/energy ratio, C-rate, gravimetric current density, gravimetric power density, volumetric current density or volumetric power density.

The term “operably coupled” refers to a connection between two or more storage devices, which allows for a transfer of energy between the two or more storage devices. The term “operable to be charged” refers to a connection between two or more electrochemical cells, which allows for a transfer of charge between the two or more electrochemical cells. The transfer of energy or charge can be direct (e.g. via a wire, including optional controllers as described herein, or via a “wireless” charging system such as an inductive charging system) or indirect (e.g. via a storage device, such as an additional electrochemical cell, such as the carrier described herein).

The second C-rate of the Receiver being equal to or greater than the first C-rate of the charger means that the battery of the Receiver is operable to be charged at a greater C-rate than the battery of the Charger can provide.

Preferably, the working electrode is the anode during a discharge step.

In some embodiments at least one of the first plurality of battery cells comprises a working electrode active material comprising a metal oxide. In some embodiments at least one of the second plurality of battery cells comprises a working electrode active material comprising a metal oxide. In some embodiments the first plurality and the second plurality of battery cells comprise a working electrode active material comprising a metal oxide.

In some embodiments, the system further comprises a Carrier comprising a third storage device including a third plurality of battery cells, wherein the carrier is operably coupled to the charger and is operable to be charged at a third C-rate by the charger, wherein the carrier is operably coupled to the receiver and is operable to discharge at a fourth C-rate to charge the receiver, wherein the third C-rate is greater than the first C-rate, and wherein the second C-rate is greater than the fourth C-rate.

In some embodiments the fourth C-rate may be equal to or greater than the third C-rate.

In some embodiments the third plurality of battery cells comprises a working electrode active material comprising a metal oxide.

In some embodiments the system includes two or more carriers. Preferably the operable C-rates of the carriers increase from the carrier adjacent the charger to the carrier adjacent the receiver.

In some embodiments the charger is a static device. A static device may be a device which is not portable, for example because it is connected directly to the electrical grid. In another embodiment the charger may be a mobile device. A mobile device may be a device which can be disconnected from a source of power and moved, for example to a receiving device that is not portable. Accordingly, a mobile device may be carried by a user, may be on wheels, may be self-propelled, and may be incorporated into a flying device such as a drone.

The battery of the receiving device—the Carrier or the Receiver—may be charged to any state of charge up to 100% state of charge. Likewise, the battery of the charging device—the Charger or the Carrier—may be discharged to any state of charge down to 0% state of charge. Accordingly, multiple receiving devices may be charged from a single charging device with each receiving device partially discharging the battery of the charging device. Alternatively, multiple charging devices could be used to charge a single receiving device with each charging device partially charging the battery of the receiving device. Further, the charging process may partially discharge the battery of a charging device and partially charge the battery of a receiving device in accordance with, for example, user instructions.

In some embodiments the metal oxide is a niobium oxide or niobium metal oxide. The metal oxide comprising the working electrode active material is preferably a niobium-based material, such as niobium oxide, or a niobium metal oxide such as niobium nickel oxide, niobium tungsten oxide, niobium titanium oxide, niobium molybdenum oxide, niobium aluminium oxide, niobium gallium oxide, niobium germanium oxide, niobium copper oxide, or niobium zinc oxide for example, as described in WO 2019/234248, the content of which is incorporated herein by reference in its entirety.

In some embodiments the working electrode active material may comprise Nb₂O₅, Nb₂NiO₆, Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, Nb₂W₁₅O₅₀, Nb₂WO₈, Nb₂TiO₇, Nb₁₀Ti₂O₂₉, Nb₂₄TiO₆₂, Nb₂Mo₃O₁₄, Nb₁₄Mo₃O₄₄, Nb₁₂MoO₄₄, Nb₁₁A₁₁O₂₉, Nb₁₁GaO₂₉ Nb₄₉GaO₁₂₄, Nb₁₈GeO₄₇, Nb₃₄Cu₂O₈₇, or Nb₃₄Zn₂O₈.

This material has favourable lithium ion diffusion properties and thus exhibits superior performance even where micron-sized particles of the niobium-based material are used. Accordingly, a working electrode comprising a niobium-based material, such as niobium oxide or a niobium metal oxide, exhibits extremely high volumetric energy density and high capacity at high rates of charging and discharging, which provides for a higher C-rate. In some embodiments the Charger is operable to provide a power density of at least 2 watts per cubic centimetre. In some embodiments the charger is configured to charge the Receiver in less than 1 minutes, wherein the charge comprises charging a cell of the receiver from less than 0.5V to greater than 3V.

In some embodiments a voltage profile of a cell of the first storage device is the same as a voltage profile of a cell of the second storage device. Preferably the first storage device and the second storage device have a sloping, rather than flat, voltage profile.

The use of niobium-based materials is also beneficial because it allows symmetrical charge and discharge rates. Put differently, it is possible to charge and discharge a niobium-based cell at the same or similar C-rates. This is not possible for lithium batteries, which require size disparities to achieve the same result.

Alternatively, the metal oxide comprising the working electrode active material may comprise another metal oxide such as lithium titanium oxide, titanium dioxide, silicon oxide, or vanadium oxide. These metal oxides typically display similar electrochemical properties to the niobium oxide or niobium metal oxide.

The metal oxide could be combined with other suitable active materials such as carbon, graphite, and other metal oxides.

The components of the battery as used in the charging device of the second embodiment are as described below.

In a second embodiment the invention generally relates to a method of charging a receiver battery from a charging device. Generally, the charging device comprises a battery composed of cells capable of fast charging and fast discharging, each cell of the battery comprising a working electrode active material comprising a metal oxide, (e.g. a niobium-containing metal oxide) together with a controller, charging engine and power connector, to enable fast discharging to a receiver battery. The charging device is operable to be connected to an electric vehicle (EV) or other receiver device to charge the integral battery of the receiver device. The receiver battery of the receiver device can be charged to any state of charge up to 100%.

Preferably, to make the charging device portable and improve its practical use, it is physically smaller than the battery of the EV or another receiver device. Typically, the output power/energy ratio of the charging device exceeds the input power/energy ratio of the receiver battery it is charging. Moreover, to further increase the utility of the charger, it typically has the capability to be re-charged quickly, such as with an input power/energy ratio similar to or greater than that of its output. This allows the battery to be replenished from, for example, a DC rapid charger.

Preferably, the cells of the battery in the charging device should be capable of discharging at a power/energy ratio of 3 or greater, further preferably 5 or greater, most preferably 10 or greater. Power energy ratio may be used interchangeably with C-rate.

Preferably, the cells of the battery in the charging device should be capable of charging at a power/energy ratio of 3 or greater, further preferably 5 or greater, most preferably 10 or greater.

Preferably, the charging device has a capacity smaller than that of the device it is employed to charge. Preferably, the charging device occupies a volume of 1 m³ or less.

Typically, the charging device has a smaller total capacity than the receiver battery of the receiver device, such as an EV.

The components of the electrochemical cell as used in the charging device of the second embodiment are as described below. The cells comprise an anode and/or cathode which comprise a metal oxide, preferably a niobium-containing metal oxide such as a niobium tungsten oxide, niobium titanium oxide and/or niobium molybdenum oxide for example, as described in WO 2019/234248, the contents of which are hereby incorporated by reference in their entirety.

WO 2019/234248 and WO 2021/074406 describe various niobium-based electrochemical cells. These documents do not describe the use of the cells in a charging device to charge a receiver battery.

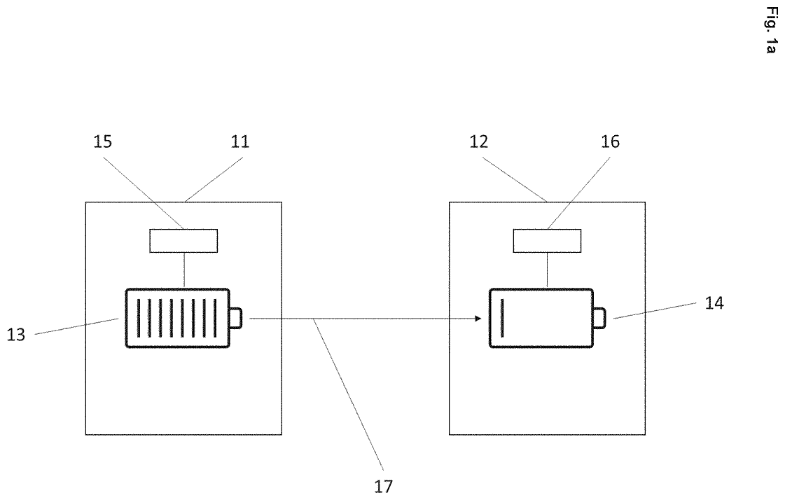

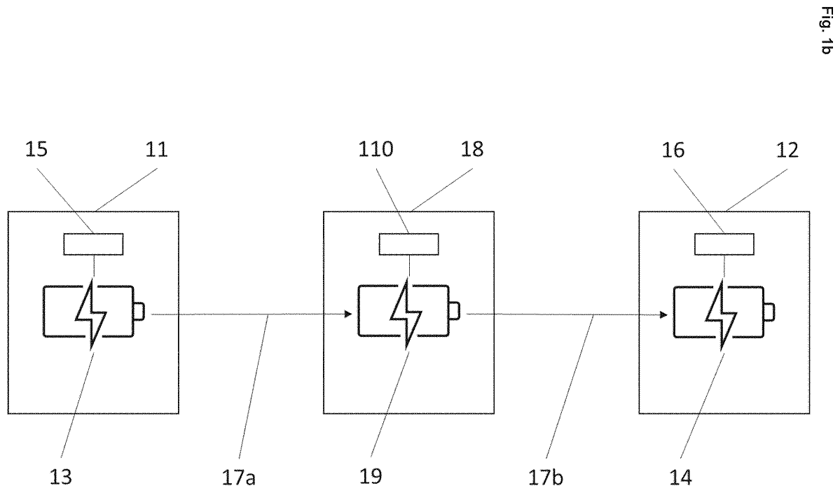

WO 2016/205124 describes a supplementary battery for an e-reader (see FIG. 1). Paragraph [0032] says the cell may comprise a mixed metal oxide, but does not refer to the preferred niobium-metal oxides. The mixed metal oxide is said to be included as part of the cathode, not the anode as in the preferred battery chemistry of the present invention. The document does not mention a C-rate of the battery.

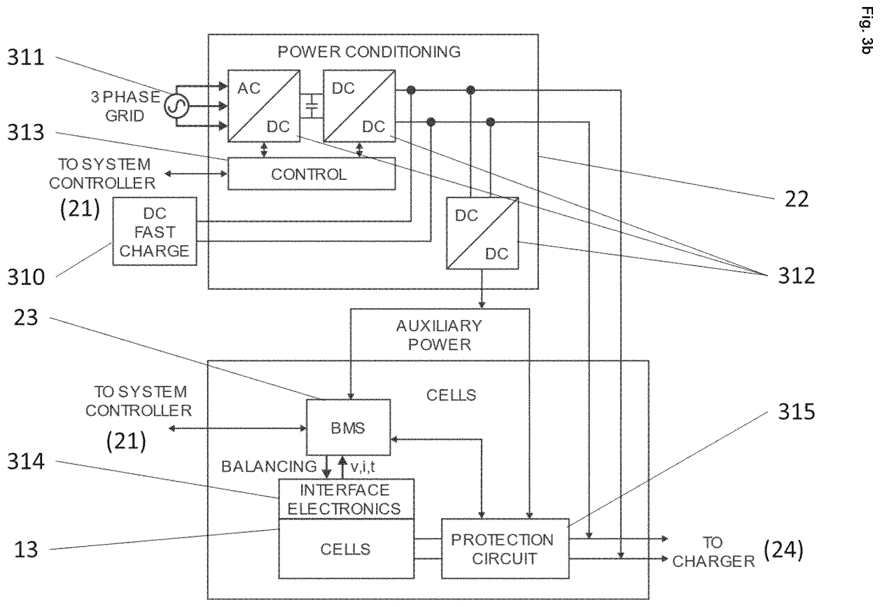

US 2020/0070655 describes a charging system (see FIG. 3) where a reservoir battery is discharging at 1C to a receiver battery (car) which is charging at 10C. US 2020/0070655 describes a reservoir including a selenium-based cathode or anode. The discharge rate of the reservoir battery is only 1C.

WO 2013/039753 relates to an energy management system, which in one embodiment includes a battery array arranged to charge the battery pack of a car (see paragraph [0078] and FIG. 1). The system also discretely switches between the batteries in the battery array, rather than adjusting the discharge rate of the battery in the charging device.

GB 2552483 relates to a battery-to-battery charging system for a car. A high voltage battery (used to drive the car) is arranged to transfer power to a low voltage battery used for the car's electrical systems (see page 17-18). The two batteries are constantly connected, rather than in separable connection, and the system is initiated when the voltage of the smaller battery falls below a threshold.

US 2020/0274382 describes an energy storage unit for recharging a battery of a vacuum cleaner (see paragraph [0182]). The document does not describe an electrochemical cell having the preferred niobium-metal oxides. The document suggests using a capacitor instead of a battery, to provide higher rates.

WO 2016/205124, US 2020/0070655, WO 2013/039753, GB 2552483 and US 2020/0274382 do not describe a releasable power connector, charging engine and controller. The documents also do not disclose a step of sending data on the battery and adjusting the discharge rate to increase the discharge rate to a rate of 3C or more. The preferred niobium-metal oxide-based anode cell chemistry is also not mentioned in these documents.

Method of Charging a Receiver Battery from a Charging Device

In a first aspect there is provided a method of charging a receiver battery from a charging device, the charging device comprising:
a battery, wherein the battery comprises an electrochemical cell,
a power connector, in separable electrical connection with the receiver battery,
a charging engine in electrical communication with the battery and the power output,
and
a controller in communication with the battery and the charging engine; and the method comprising the steps of:
discharging the battery to the power connector, using the charging engine;
sending data on the condition of the battery to the controller; and
adjusting the discharge rate of the battery to increase the discharge rate, wherein the
discharge rate is increased to a rate of 3C or more, in response to the data.

The method may be a computer-implemented method. Any or all steps of the method may be computer-implemented. For example, the data sending step and the rate adjustment step may be computer-implemented.

EP 3026780 describes a portable power bank including a built-in battery, power input/output, a converter and a protection circuit (see FIG. 1B and paragraphs [0020]-[0021]). The protection circuit (BMS) is said to monitor the battery to start/stop charging (see paragraphs [0026]-[0027]). The document proposes using a lithium-ferrum phosphate battery, which has a low discharge rate (see paragraph [0029]).

EP 2612786 relates to a system for transferring power between batteries in two electrical vehicles. The system includes a battery with a buck-booster converter and power connector, as well as a pack controller (see FIG. 1, abstract and paragraphs [0017]-[0021]). The pack controller is said to monitor data from the system and communicate with the batteries to control the power transfer (see paragraphs [0034]-[0035]). EP 2612786 suggests limiting the rate of charge (see Table II), but this limit is not based on data from the battery.

US 2021/0305838 is directed to a portable power station for a battery charger (see paragraph [0018] and [0020]) and includes battery modules connected to an energy output and a switching system (see FIG. 1). The switching system appears to monitor the conditions of the batteries (see paragraph [0028]) and charge/discharge to other components (see paragraph [0036]-[0038]). The monitoring of the condition of the batteries is used to determine if the batteries are connected, so the battery management system can select which of the battery modules can be used to supply power to the load.

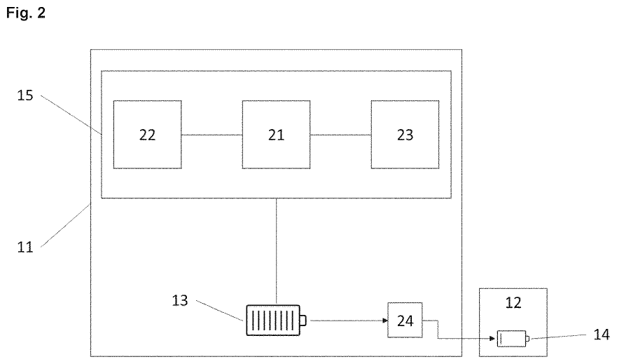

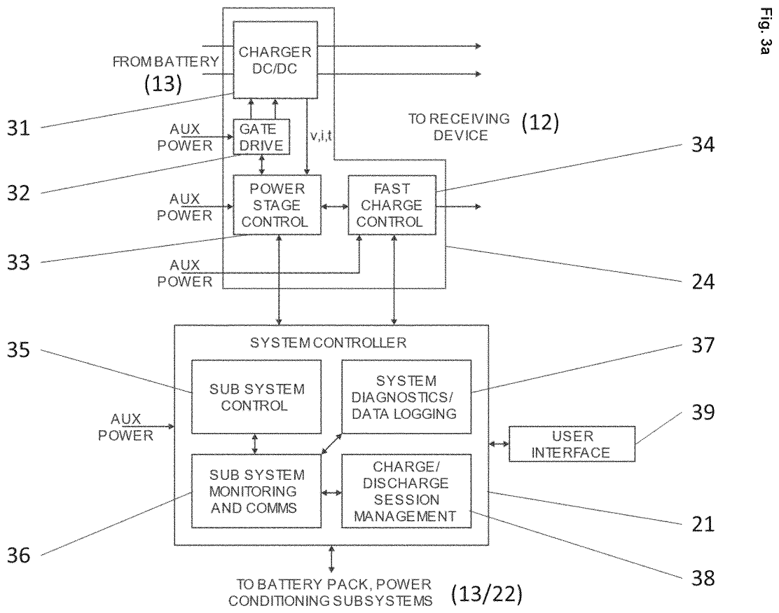

US 2014/0354050 describes a backup battery system where the power supply, battery, and load are in series. The backup battery is for suppling power to a load. The system includes a rechargeable battery, a charging/discharging switch for controlling charge/discharge and a control circuit which monitors the battery capacity and current information (see FIG. 2 and paragraph [0011]). In specific embodiments the load may be another battery (e.g. phone battery, see paragraph [0027]). This system controller switches on/off during charging and discharging of the power bank.

US 2014/0159492 concerns a power bank circuit. Paragraph [0021] explains that the circuit includes a power conversion circuit and various monitoring or temperature detecting circuits to monitor the cells. A current distribution circuit controller signals to a charger circuit to adjust the output current of the cell depending on the condition of the cell.

US 2012/0056581 describes charging a portable device from a vehicle battery. The document says that a controller monitors the voltage of the vehicle batteries and transforms the voltage appropriately. The system uses a lookup table with ratios of portable device “charging quantity” to EV battery “voltage bandwidth”.

US 2008/0238356 describes a portable charger. The controller receiver measurements (e.g. temperature, voltage, etc.) from the battery and adjusts the current flow from the battery in response (see paragraphs [0082]-[0085]), to avoid overcharging.

EP 3026780, EP 2612786, US 2021/0305838, US 2014/0354050, US 2014/0159492, US 2012/0056581 and US 2008/0238356 do not describe a step of adjusting the discharge rate such that the discharge rate is increased to a rate of 3C or more in response to data on the batteries. None of the documents mention the preferred niobium-metal oxide based battery chemistry.

### Receiver Battery

The receiver battery may refer to the battery of a receiver device. The receiver battery and the receiver device are not particularly limited, but may be an EV, a UPS or a personal computer device such as a laptop, tablet of phone. This refers to the battery which is being charged by the charging device of the invention.

The receiver battery typically comprises a plurality of electrochemical cells, comprising a working electrode, a counter electrode and an electrolyte. The electrochemical cell may be a lithium ion cell.

The receiver battery may comprise any number of electrochemical cells and may be made up of one or more sub-batteries. The battery may be a modular system such that sub-batteries are replaceable.

The receiver battery may comprise electrochemical cells which are the same or different to the electrochemical cells making up the battery of the charging device.

Preferably, the maximum operable discharge rate of the charger battery is higher than the higher maximum operable charge rate of the receiver battery. The maximum operable discharge rate of the battery is the maximum rate of discharge where the capacity retention for 100 complete cycles is over 90%, preferably over 95%, more preferably over 97%, even more preferably over 99%.

Preferably, the total capacity of the charger battery is lower than the total capacity of the receiver battery.

In some embodiments, the receiver device may comprise a charging device similar to the charging device of the invention, as described herein. In some embodiments the receiver device communicates with the charging device, for example, via the power connector. In some embodiments, the controller of the charging device receives data from the receiver device and/or the receiver battery. The data may be sent from the receiver battery to the controller of the charging device and used to increase the rate of discharge of the battery, as described below.

The battery may also be referred to as “a plurality of battery cells”. In the first embodiment, the first plurality of battery cells refers to the battery of the charger (i.e. charging device). In the first embodiment, the second plurality of battery cells refers to the battery of the receiver (i.e. the receiver device). In the first embodiment, the third plurality of battery cells refers to the battery of a carrier.

### Discharge Step

The method of charging a receiver battery from a charging device comprises a step of:
discharging the battery to the power connector, using the charging engine.

This step may be known as the “discharge step”.

The discharge step is a step of discharging the battery of the charging device, to provide an output power to the power connector, in order to charge a receiver battery separably connected to the power connector. The charging engine may control and/or condition the output power. The charging engine may control the rate of discharge of the battery.

The discharge step may include inverting the output power (i.e. changing direct current (DC) to alternating current (AC)) or converting the output power (i.e. AC to DC, or DC to DC). The converter or inverter is typically comprised in the charging engine. Suitable inverters or converters are known in the art.

The discharge step may include changing the voltage of the output power. Typically, a converter is comprised in the charging engine. Suitable DC-DC converters are known in the art, such as buck, boost, or a buck-boost converter. Suitable AC-AC converters are known in the art, such as transformers.

The discharge step may include increasing or decreasing the voltage of the output power, preferably increasing the voltage of the output power. The increase in the voltage may be determined by the preferred voltage of the receiver battery.

In some embodiments, the discharge step comprises converting the discharge power from AC to DC using a converter in the charging engine.

The discharge step may include power conditioning the output power. Typically, a power conditioner is comprised in the charging engine. Suitable power conditioners are known in the art, such as surge protectors, frequency correctors and voltage correctors. The power conditioning may improve stability of the output power.

Typically, the discharge step starts after a signal from the controller. The controller may signal to the charging engine to start the discharge step. The controller may be triggered to send a signal to start discharging based on an input, such as an input from a user (e.g. via an input to a user interface) or an input from the charging device (e.g. from the connection of a receiving battery). The connection of a receiving battery may be identified by a sensor in the power connector, by detection in a change in electrical properties (e.g. voltage or resistance) at the power connector, or by a signal sent from the receiver battery (e.g. the receiver device) to the controller.

In some embodiments, the method comprises a step of starting discharging, wherein the controller signals to the charging engine to start discharging the battery. In some embodiments, the step of starting discharging is triggered by connection of a receiver battery to the power connector.

Typically, the discharge step stops after a signal from the controller. The controller may signal to the charging engine to stop the discharge step. The controller may be triggered by the same means as for starting the discharge step, as described above. The controller may be triggered by data on the condition of the battery, such as the state of charge of the battery dropping below a minimum threshold (e.g. 10%).

In some embodiments, the method comprises a step of stopping discharging, wherein the controller signals to the charging engine to stop discharging the battery. In some embodiments, the step of stopping discharging is triggered by disconnection of a receiver battery to the power connector.

### Data Sending Step

The method of charging a receiver battery from a charging device comprises a step of:
sending data on the condition of the battery to the controller.

This step may be known as the “data sending” step.

Typically, the data sending step involves transferring data about the battery to the controller. The data sending step may further comprise sending data about the charging engine to the controller.

The data is on the condition of the battery and/or charging engine. The data may be measured using any suitable means. The data may be measured by the charging engine or a battery management system (BMS). The charging engine and/or battery management system typically send the data about the condition of the battery to the controller. The data is any which can be used to indicate the condition of the battery during discharge. The data may be used to determine if the battery can be discharged more quickly, or if the battery needs to be discharged more slowly.

In some embodiments, the data is selected from the list comprising at least one of battery voltage, battery temperature, battery isolation resistance, discharge current, state of charge of the battery, state of balancing of the battery, and power availability of the battery.

In some embodiments, the data comprises battery voltage, discharge current, and battery temperature.

The data may be measured using any suitable means known in the art. For example, voltage may be measured using a voltmeter, current by an ammeter, resistance by an ohmmeter, temperature by a thermocouple, isolation resistance by a high input impedance ohmmeter, and state of charge, state of balancing and power availability by voltmeter or indirectly by an ammeter (e.g. by “coulomb counting”).

The data may be sent to the controller by any suitable means known in the art, such as by electronic communication.

The data may be processed before sending to the controller. The data may be processed by the BMS or charging engine, and then sent to the controller. Alternatively, unprocessed data may be sent to the controller, and the data may be processed by the controller.

The frequency of the data sending step is suitable to determine the condition of the battery and whether the discharge rate can be increased. The frequency refers to how often the data is sent from the battery and charging engine to the controller. The frequency may also refer to the measurement frequency of the data at the battery and charging engine. The frequency of the data sending step may be from 0.01 to 10 seconds, preferably from 0.1 to 1 seconds, more preferably from 0.2 to 0.5 seconds. The frequency of the data sending step is about every 0.25 seconds.

### Rate Adjustment Step

The method of charging a receiver battery from a charging device comprises a step of:
adjusting the discharge rate of the battery to increase the discharge rate, wherein the discharge rate is increased to a rate of 3C or more, in response to the data.

This step may be known as the “rate adjustment” step.

Typically, the rate adjustment step involves reviewing data from the data sending step and adjusting the discharge rate in response to the data. Generally, the controller compares the data against an acceptable range, and determines if the discharge rate should be increased or decreased. If the data is inside the acceptable range the rate of discharge is increased. If the data is outside of the acceptable range the rate of discharge is decreased. The controller may signal to the charging engine whether to increase or decrease the rate of discharge.

The rate adjustment step increases the discharge rate to a rate of 3C or more. Preferably, the rate adjustment step increases the discharge rate to a rate of 5C or more, preferably 10C or more, more preferably 20 C or more. Alternatively, the rate adjustment step increases the discharge rate to a power density of 1500 mW·g⁻¹ or more, preferably 1800 mW·g⁻¹ or more, more preferably 2100 mW·g⁻¹ or more.

In some embodiments, the rate adjustment step increases the discharge rate to provide an output power of 100 kW or more, preferably 200 kW or more, more preferably 300 kW or more, even more preferably 400 kW or more.

In the first embodiment, the discharge rate of the battery is increased to a discharge rate which is lower than the charge rate of a receiver battery.

In the second embodiment, the discharge rate of the battery is increased to a discharge rate which is higher than the charge rate of a receiver battery.

The rates of discharge of the battery are described in more detail below.

The battery of the invention allows high discharge rates to be achieved, while maintaining the conditions of the battery within an acceptable range. The controller may increase the discharge rate when the data is inside an acceptable range.

In some embodiments, the discharge rate of the battery is increased by 1C or more, preferably 2C or more, more preferably 3C or more. This increase is compared to an initial rate of discharge. In some embodiments, the discharge rate of the battery is increased by 100 mW·g⁻¹ or more, preferably 300 mW·^{g-1} or more, more preferably 500 mW·g⁻¹ or more.

This increase is compared to an initial rate of discharge. The rate adjustment step may balance the electrochemical cells of the battery. The rate adjustment step may adjust the discharge rate of individual or groups of electrochemical cells of the battery, thereby balancing the electrochemical cells of the battery. The rate adjustment step may increase the rate of discharge for cells having a higher state or charge (e.g. higher voltage) and/or decrease the rate of discharge for cells having a lower state of charge (e.g. lower voltage). This may balance the cells in the battery, which reduces the amount of overvoltage or undervoltage of any individual cell. This reduces potential damage to the cells and increase the safety of the battery during discharge.

In some embodiments the step of adjusting the discharge rate of the battery to increase the discharge rate comprises independently adjusting the discharge rate of two or more electrochemical cells of the battery, to balance the two or more electrochemical cells of the battery.

Balancing the electrochemical cells uses the same data sending step and adjustment steps as for the battery, as described herein, except the data relates to individual or groups of electrochemical cells.

In some embodiments, the rate adjustment step comprises the steps of:
(i) determining if the data on the condition of the battery sent to the controller is inside a range, and
(ii) increasing the discharge rate if the data is inside the range, or decreasing the discharge rate if the data is outside the range; and
(iii) repeating steps (i)-(ii) until the controller signals the charging engine to stop discharging the battery.

Step (i) of determining if the data on the condition of the battery is inside a range may be known as the “comparison step”.

Typically, the comparison step involves determining if the data is inside a range by comparing the data against the range. The comparison is typically carried out by the controller.

For example, if the data is temperature, the controller compares the temperature data against an acceptable temperature range. For example, if the temperature of the battery is 30° C. and the range is from 10 to 50° C. then the temperature data is inside the acceptable range. Alternatively, if the temperature of the battery is 60° C. and the range is 10 to 50° C. then the temperature data is outside the acceptable range.

The range may be a predetermined range. The predetermined range may be recorded in the controller. The predetermined range may be based on the composition of the battery. The predetermined range may be determined by tests on the battery.

The range may be a variable range. The variable range may depend on external factors, such as external temperature. For example, if the external temperature increases (e.g. from 30° C. to 31° C. or more) then the variable range may be changed (e.g. the acceptable cell temperature range may be reduced from 10 to 50° C. to from 10 to 40° C. or the acceptable current range per cell may be reduced from 4 to 10 A to from 4 to 8A) to avoid overheating. Similarly, for example, if the external temperature is reduced (e.g. from 5° C. to 4° C. or less), the variable range may be changed (e.g. the acceptable temperature range may be changed from 10 to 50° C. to 5 to 50° C. or the acceptable current range changed from 4 to 10A to from 2 to 10A) to avoid damaging the battery.

The variable range may depend on the voltage of the battery cell or the state of charge of the battery. For example, if the voltage of the battery is reduced (e.g. from over 2.4V to 2.3V or less) then the variable range may be changed (e.g. the acceptable current range may be changed from 4 to 10 A to from 4 to 8A) to avoid damaging the battery when at a lower state of charge.

The variable range may depend on the receiver battery. Information about the receiver battery may be manually provided to the charging device (e.g. by a user input). Alternatively, the receiver battery may communicate with the controller of the charging device (e.g. by electronic communication, wireless communication, etc.). As explained below, the variable range may be determined by data from the receiver battery.

The variable range may operate on a discrete scale. The variable range may operate on a continuous scale.

The charging device may comprise means to measure the external factors which affect the variable range.

Step (ii) of increasing the discharge rate if the data is inside the range, or decreasing the discharge rate if the data is outside the range may be known as the optimization step.

Typically, the optimization step involves the controller increasing the rate of discharge if the conditions of the battery are inside the acceptable range, or decreasing the rate of discharge if the conditions of the battery are outside the acceptable range. Whether the condition of the battery is inside or outside the acceptable range is determined by the comparison step, as described above. This optimization step allows for the rate of discharge of the battery to be maximised, to allow for the fastest possible discharge.

Increasing or decreasing the rate of discharge is typically carried out by the controller signalling to the charging engine to increase or decrease the discharge rate. The charging engine may increase or decrease the discharge rate by any suitable means, such as changing the current of the output power or changing the voltage of the output power.

Step (iii) of repeating steps steps (i)-(ii) until the controller signals the charging engine to stop discharging the battery may be known as the repetition step.

Typically, the repetition step involves repeating steps (i)-(ii) in order to continuously adjust the rate of discharge depending on the condition of the battery. This allows the device to be responsive to the conditions of the battery, providing the fastest possible discharge without damaging the battery or discharging unsafely.

The steps may be repeated at a frequency equivalent to the data sending step. The steps may be repeated every 0.01 to 10 seconds, preferably from 0.1 to 1 seconds, more preferably from 0.2 to 0.5 seconds. The frequency of the data sending step is about every 0.25 seconds.

In some embodiments the method further comprises the steps of:
sending data about the condition of the receiver battery to the controller, and
adjusting the discharge rate of the battery to increase the discharge rate, wherein the discharge rate is increased to a rate of 3C or more, in response to data on the condition of the receiver battery.

The step of sending data from the receiver battery to the controller is the same as the data sending step described above, except that the data relates to the condition of the receiver battery, and is sent from the receiver battery to the controller of the charging device.

The step of adjusting the discharge rate of the battery to increase the discharge rate in response to data from the receiver battery can be described in the same as the rate adjustment step described above, except that the data is from the receiver battery and the acceptable range is for the receiver battery.

In some embodiments the receiver battery sends data concerning the condition of the power the receiver battery is adapted to receiver.

In some embodiments the receiver battery sends data concerning whether the receiver is adapted to be charged by AC or DC power. In some embodiments, the receiver battery sends data concerning whether the receiver is adapted to be charged at a particular voltage. In some embodiments, the receiver battery sends data concerning whether the receiver is adapted to be charged at a particular power. The step of adjusting the discharge rate may then further comprise a step of selecting the type of power (e.g. AC or DC), voltage, or power, in response to the data sent from the receiver battery.

In some embodiments the step of adjusting the discharge rate of the battery to increase the discharge rate to a rate of 3C or more, in response to the data from the receiver battery comprises:
(i) determining if the data sent from the receiver battery to the controller is inside a range, and
(ii) increasing the discharge rate if the data is inside the range, or decreasing the discharge rate if the data is outside the range; and
(iii) repeating steps (i)-(ii) until the controller signals the charging engine to stop discharging the battery.

Steps (i), (ii) and (iii) are as described above, for the data on the condition of the battery of the charging device, except that the data on the condition of the receiver battery.

Preferably, the controller monitors data on the condition of both the battery of the charging device and the receiver battery, and increase the rate of discharge of the battery to the maximum rate while keeping the conditions of the both batteries inside an acceptable range. In this way, the rate of charging the receiver battery is maximised and the charge time reduced, without damaging either battery or discharging unsafely.

### Charging the Battery of the Charging Device

In some embodiments, the invention further comprises the steps of:
charging the battery from a power connector, using the charging engine,
sending data on the condition of the battery to the controller, and
adjusting the charge rate of the battery to increase the charge rate, wherein the charge rate is increased to a rate of 3C or more, in response to the data.

In some embodiments the charge rate of the battery is increased to a charge rate of 5C or more, preferably 10C or more, more preferably 20 C or more. Alternatively, the charge rate of the battery is increased to a power density of 1500 mW·g⁻¹ or more, preferably 1800 mW·g⁻¹ or more, more preferably 2100 mW·g⁻¹ or more.

In some embodiments, the charge rate is such that the charging device receives an input power of 100 kW or more, preferably 200 kW or more, more preferably 300 kW or more, even more preferably 400 kW or more.

In some embodiments the charge rate of the battery is increased by 1C or more, preferably 2C or more, more preferably 3C or more. This increase is compared to an initial rate of discharge. In some embodiments, the charge rate of the battery is increased by 100 mW·g⁻¹ or more, preferably 300 mW·g⁻¹ or more, more preferably 500 mW·g⁻¹ or more. This increase is compared to an initial rate of discharge.

In the first embodiment, the charge rate of the battery is increased to a discharge rate which is lower than the discharge rate of the battery.

Additionally or alternatively, in the first embodiment, the charge rate of the battery is increased to a charge rate which is lower than the charge rate of the receiver battery.

In the second embodiment, the charge rate of the battery is increased to a discharge rate which is higher than the discharge rate of a receiver battery.

Additionally or alternatively, in the second embodiment, the charge rate of the battery is increased to a charge rate which is higher than the charge rate of a receiver battery.

Additionally or alternatively, the charge rate of the charger device battery may be increased to a charge rate which is more than the discharge rate of the charger device battery. Preferably, the charger device battery is increased to a charge rate of 3C or more, such as a 5C or more, 10C or more, 15C or more, 20C or more, 25C or more, 30C or more, 35C or more, 40C or more, 50C or more, 60C or more, wherein and the charger device battery has a discharge rate of less than the charge rate. More preferably, the charge rate of the charger device battery is increased to a charge rate of 60C or more the charger device battery has a discharge rate of less than 60C.

The rates of charge of the battery are described in more detail below.

The step of charging the battery from the power connector, using the charging engine, may be known as the “charge step”.

The charge step is a step of charging the battery of the charging device, from a power supply separably connected to the power connector. The charging engine may control and/or condition the input power.

The charge step may include inverting the input power (i.e. changing direct current (DC) to alternating current (AC)) or converting the input power (i.e. AC to DC, or DC to DC). The converter or inverter is typically comprised in the charging engine. Suitable inverters or converters are known in the art.

The charging step may include changing the voltage of the input power. Typically, a DC-DC converter is comprised in the charging engine. Suitable DC-DC converters are known in the art, such as buck, boost, or a buck-boost converters. Suitable AC-AC converters are known in the art, such as transformers. The change in the voltage may be determined by the preferred voltage of the battery and the voltage of the power supply.

The charging step may include increasing the voltage of the input power. The charging step may include decreasing the voltage of the input power.

In some embodiments, the charging step comprises converting the input power from AC to DC using a converter in the charging engine.

The charging step may include power conditioning the input power. Typically, a power conditioner is comprised in the charging engine. Suitable power conditioners are known in the art, such as surge protectors, frequency correction and voltage correction. The power conditioners may increase the uniformity of the input power.

Typically, the charge step starts after a signal from the controller. The controller may signal to the charging engine to start the charge step. The controller may be triggered to send a signal to start charging based on an input, such as an input from a user (e.g. pressing a button or an input via a user interface) or an input from the charging device (e.g. from the connection of a power supply). The connection of a power supply may be identified by a sensor in the power connector, by detection in a change in electrical properties (e.g. voltage or resistance) at the power connector, or by a signal sent from the power supply to the controller.

In some embodiments, the method comprises a step of starting charging, wherein the controller signals to the charging engine to start charging the battery. In some embodiments, the step of starting discharging is triggered by connection of a power supply to the power connector.

Typically, the charge step stops after a signal from the controller. The controller may signal to the charging engine in the same way as described above for starting charging.

In some embodiments, the method comprises a step of stopping charging, wherein the controller signals to the charging engine to stop charging the battery. In some embodiments, the step of stopping charging is triggered by disconnection of a power supply to the power connector. In some embodiments, the step of stopping charging is triggered by the controller detecting that the battery is reaching a state of charge (e.g. 95%).

The step of sending data on the condition of the battery to the controller during charging can be described as above for discharging.

The step of adjusting the charge rate of the battery to increase the charge rate can be described as above for discharging. The rate adjustment step during charging can also be described as above for discharging, except the discharge is replaced with charging and the receiver battery is replaced with a power supply.

In some embodiments the power supply sends data to the controller about the power supply. The data may include if the power supply provides AC or DC power, the voltage of the power, the frequency (for AC power), the current of the power. The step of adjusting the charge rate may then further comprise a step of selecting the type of power conditioning in the charging engine (e.g. inversion or conversion, as described above), in response to the data sent from the power supply.

### Charge and Discharge Rates

For discharging, the rate adjustment step increases the discharge rate to a rate of 3C or more. This rate may be referred to herein as the “discharge rate”.

For charging, the rate adjustment step may increase the rate of charge to a rate of 3C or more. This charge rate may be referred to herein as the “charge rate”.

The rate of charge or discharge may be any suitable measurement of charge or discharge rate, such as C-rate, gravimetric current density, gravimetric power density, volumetric current density or volumetric power density.

The rate of charge may be described in terms of charge or discharge of the battery (also known as the battery of the charging device) or the receiver battery (also known as the battery of the receiver device).

Discharging the battery of the charging device typically refers to transferring energy from the battery to a receiver battery. This is typically via a charging engine and a power connector, such as an output power connector.

Charging the battery of the charging device typically refers to transferring energy from a power supply to the battery. This is typically via a charging engine and a power connector, such as an input power connector.

A “first rate” refers to the discharge rate of the battery of the charging device. A “second rate” refers to the charge rate of the battery of the receiver device. A “third rate” refers to the charge rate of a carrier, as described in the first embodiment. A “fourth rate” refers to the discharge rate of a carrier, as described in the first embodiment.

The “first”, “second”, “third” and “fourth” rates may refer to a C-rate, gravimetric current density, gravimetric power density, volumetric current density or volumetric power density. For example, these may be referred to as a “first C-rate” or a “first volumetric power density”.

The rate of charge or discharge may be described in terms of C-rate.

Herein, the term “nominal rate” refers to the actual charge or discharge rate without reference to the capacity of the cell.

The term “C-rate” has its common meaning as known in the art, referring to a normalized charge or discharge rate obtained by dividing the total discharge capacity of the cell (Ah) by a total period of time of 1 hour (h). A C-rate may be denoted in terms of “3C”, to mean a C-rate of 3.

For example, if a battery having a discharge capacity of 1.6 amp-hours (Ah) were discharged at a C-rate of 1C, the nominal discharge rate would be 1.6 amps (A), whereas if a larger battery having a discharge capacity of 2 Ah were discharged at a C-rate of 1C the nominal discharge rate would be 2A. The C-rate is a measure of the rate at which a battery is discharged relative to its maximum capacity.

The C-rate may be defined as the inverse of the number of hours to reach a defined theoretical capacity. Typically, C-rate is defined relative to one electron transfer per transition metal, e.g., for Nb₁₆W₅O₅₅, the current required to discharge at 1C=171.3 mA per gram of active material, and at 20C=3426 mA per gram of active material. The theoretical capacity is calculated by:

$${Q}_{theoretical} = \frac{nF}{3.6 m} = \frac{21 \cdot 96485.3 [ C \cdot {mol}^{- 1} ]}{3.6 [ C \cdot {mA}^{- 1} \cdot {h}^{- 1} ] \cdot 3285.65 [ g \cdot {mol}^{- 1} ]} = 171.3 mA \cdot h \cdot {g}^{- 1}$$

where n is the number of electrons transferred per formula unit, F is Faraday's constant, 3.6 is a conversion factor between Coulombs and the conventional mA·h·g⁻¹, and m is the mass per formula unit. Thus, a 1C rate corresponds to the reaction (i.e. insertion or removal) of 21 lithium ions per formula unit of Nb₁₆W₅O₅₅ in one hour, as this material contains 21 transition metals per formula unit.

The rate of charge or discharge may also be described by reference to (gravimetric) current density, for example where the current density is at least 800 mA·g⁻¹ or 1000 mA·g⁻¹. The current density can be used as an alternative to C-rate in the present invention. Current density is related to C-rate by:

$$\frac{current density ( mA \cdot {g}^{- 1} )}{capacity ( mA \cdot h \cdot {g}^{- 1} )} = \frac{1}{h} = C$$

Thus, for Nb₁₆W₅O₅₅ a current density of 800 mA·g⁻¹ corresponds to a C-rate of 4.67C and for Nb₁₃W₁₆O₉₃ a current density of 800 mA·g⁻¹ corresponds to a C-rate of 5.36C using the convention defined in this work.

All (gravimetric) capacities are quoted based on the mass of the active electrode material.

The rate of charge or discharge may also be described by reference to (gravimetric) power density. The power density can be used as an alternative to C-rate in the present invention.

Power density is directly proportional to current density. Power density is related to current density by:

$$P ower density = Current density \times Potential Difference$$

The potential difference of the cell may be 2.0 V or more, preferably 2.25 V or more, more preferably 2.5 V or more when fully charged. Thus, the power density of the cell may be calculated by taking the current density as described above and multiplying by the potential difference of the cell.

All (gravimetric) power densities are quoted based on the mass of the active electrode material.

The rate of charge or discharge may also be described by reference to (volumetric) power density. The volumetric power density can be used as an alternative to C-rate in the present invention.

The volumetric power density is related to the gravimetric power density by the following equation:

$$Volumetric power density = Gravimetric powder density \times density of working electrode$$

All (volumetric) power densities are quoted based on the volume of the active electrode material.

### Charge Rates of the First Embodiment

In the first embodiment, the first C-rate may be a C-rate of 5C or less, such as a C-rate 5C or less with respect to one electron transfer per transition metal per formula unit of working electrode active material. Preferably, the first C-rate is 10C or less, 15C or less, 20C or less, 25C or less, 30C or less, 35C or less, 40C or less, 50C or less, 60C or less or 80C or less.

The second C-rate is equal to or greater than the first C-rate. The second C-rate may be a C-rate of 5C or more, such as a C-rate of 5C or more with respect to one electron transfer per transition metal per formula unit of working electrode active material. Preferably, the second C-rate is 10C or more, 15C or more, 20C or more, 25C or more, 30C or more, 35C or more, 40C or more, 50C or more, 60C or more or 80C or more.

In the first embodiments, the third C-rate is equal to or greater than the first C-rate. The third C-rate may be a C-rate of 5C or more, such as a C-rate of 5C or more with respect to one electron transfer per transition metal per formula unit of working electrode active material. Preferably, the third C-rate is 10C or more, 15C or more, 20C or more, 25C or more, 30C or more, 35C or more, 40C or more, 50C or more, 60C or more or 80C or more.

In the first embodiments the second C-rate is equal to or greater than the fourth C-rate. The fourth C-rate may be a C-rate of 5C or less, such as a C-rate 5C or less with respect to one electron transfer per transition metal per formula unit of working electrode active material. Preferably, the fourth C-rate is 10C or less, 15C or less, 20C or less, 25C or less, 30C or less, 35C or less, 40C or less, 50C or less, 60C or less or 80C or less.

In the first embodiments, the first plurality of battery cells are operable to discharge at a first current density and the second plurality of battery cells are operable to charge at a second current density. Thus, in some embodiments the second current density is equal to or greater than the first current density.

Preferably, the first current density is 750 mA·g⁻¹ or less. Preferably, the first current density is 800 mA·g⁻¹ or less, 850 mA·g⁻¹ or less, 900 mA·g⁻¹ or less, 950 mA·g⁻¹ or less, 1000 mA·g⁻¹ or less, 1050 mA·g⁻¹ or less, 1100 mA·g⁻¹ or less, 1200 mA·g⁻¹ or less, or 1300 mA·g⁻¹ or less.

Preferably, the second current density is 750 mA·g⁻¹ or more. Preferably, the second current density is 800 mA·g⁻¹ or more, 850 mA·g⁻¹ or more, 900 mA·g⁻¹ or more, 950 mA·g⁻¹ or more, 1000 mA·g⁻¹ or more, 1050 mA·g⁻¹ or more, 1100 mA·g⁻¹ or more, 1200 mA·g⁻¹ or more, or 1300 mA·g⁻¹ or more.

In the first embodiments the third plurality of battery cells are operable to charge at a third current density and to discharge at a fourth current density. Thus, in some embodiments the third current density is equal to or greater than the first current density, and the second current density is equal to or greater than the fourth current density.

Preferably, the third current density is 750 mA·g⁻¹ or more. Preferably, the third current density is 800 mA·g⁻¹ or more, 850 mA·g⁻¹ or more, 900 mA·g⁻¹ or more, 950 mA·g⁻¹ or more, 1000 mA·g⁻¹ or more, 1050 mA·g⁻¹ or more, 1100 mA·g⁻¹ or more, 1200 mA·g⁻¹ or more, or 1300 mA·g⁻¹ or more.

Preferably, the fourth current density is 750 mA·g⁻¹ or less. Preferably, the fourth current density is 800 mA·g⁻¹ or less, 850 mA·g⁻¹ or less, 900 mA·g⁻¹ or less, 950 mA·g⁻¹ or less, 1000 mA·g⁻¹ or less, 1050 mA·g⁻¹ or less, 1100 mA·g⁻¹ or less, 1200 mA·g⁻¹ or less, or 1300 mA·g⁻¹ or less.

In the first embodiments, the first plurality of battery cells are operable to discharge at a first power density and the second plurality of battery cells are operable to charge at a second power density. Thus, in some embodiments the second power density is equal to or greater than the first power density.

Preferably, the first power density is 1500 mW·g⁻¹ or less. Preferably, the first power density is 1600 mW·g⁻¹ or less, 1700 mW·g⁻¹ or less, 1800 mW·g⁻¹ or less, 1900 mW·g⁻¹ or less, 2000 mW·g⁻¹ or less, 2100 mW·g⁻¹ or less, 2200 mW·g⁻¹ or less, 2400 mW·g⁻¹ or less, or 2600 mW·g⁻¹ or less.

Preferably, the second power density is 1500 mW·g⁻¹ or more. Preferably, the second power density is 1600 mW·g⁻¹ or more, 1700 mW·g⁻¹ or more, 1800 mW·g⁻¹ or more, 1900 mW·g⁻¹ or more, 2000 mW·g⁻¹ or more, 2100 mW·g⁻¹ or more, 2200 mW·g⁻¹ or more, 2400 mW·g⁻¹ or more, or 2600 mW·g⁻¹ or more.

In the first embodiments the third plurality of battery cells are operable to charge at a third power density and to discharge at a fourth power density. Thus, in some embodiments the third power density is equal to or greater than the first power density, and the second power density is equal to or greater than the fourth power density.

Preferably, the third power density is 1500 mW·g⁻¹ or more. Preferably, the third power density is 1600 mW·g⁻¹ or more, 1700 mW·g⁻¹ or more, 1800 mW·g⁻¹ or more, 1900 mW·g⁻¹ or more, 2000 mW·g⁻¹ or more, 2100 mW·g⁻¹ or more, 2200 mW·g⁻¹ or more, 2400 mW·g⁻¹ or more, or 2600 mW·g⁻¹ or more.

Preferably, the fourth power density is 1500 mW·g⁻¹ or less. Preferably, the fourth power density 1600 mW·g⁻¹ or less, 1700 mW·g⁻¹ or less, 1800 mW·g⁻¹ or less, 1900 mW·g⁻¹ or less, 2000 mW·g⁻¹ or less, 2100 mW·g⁻¹ or less, 2200 mW·g⁻¹ or less, 2400 mW·g⁻¹ or less, or 2600 mW·g⁻¹ or less.

In the first embodiments, the first plurality of battery cells are operable to discharge at a first volumetric power density and the second plurality of battery cells are operable to charge at a second volumetric power density. Thus, in some embodiments the second volumetric power density is equal to or greater than the first volumetric power density.

Preferably, the first volumetric power density is 1500 mW·(cm³)⁻¹ or less. Preferably, the first volumetric power density is 1600 mW·(cm³)⁻¹ or less, 1700 mW·(cm³)⁻¹ or less, 1800 mW·(cm³)⁻¹ or less, 1900 mW·(cm³)⁻¹ or less, 2000 mW·(cm³)⁻¹ or less, 2100 mW·(cm³)⁻¹ or less, 2200 mW·(cm³)⁻¹ or less, 2400 mW·(cm³)⁻¹ or less, or 2600 mW·(cm³)⁻¹ or less.

Preferably, the second volumetric power density is 1500 mW·(cm³)⁻¹ or more. Preferably, the second volumetric power density is 1600 mW·(cm³)⁻¹ or more, 1700 mW·(cm³)⁻¹ or more, 1800 mW·(cm³)⁻¹ or more, 1900 mW·(cm³)⁻¹ or more, 2000 mW·(cm³)⁻¹ or more, 2100 mW·(cm³)⁻¹ or more, 2200 mW·(cm³)⁻¹ or more, 2400 mW·(cm³)⁻¹ or more, or 2600 mW·(cm³)⁻¹ or more.

In the first embodiments the third plurality of battery cells are operable to charge at a third volumetric power density and to discharge at a fourth volumetric power density. Thus, in some embodiments the third volumetric power density is equal to or greater than the first volumetric power density, and the second volumetric power density is equal to or greater than the fourth volumetric power density.

Preferably, the third volumetric power density is 1500 mW·(cm³)⁻¹ or more. Preferably, the third volumetric power density is 1600 mW·(cm³)⁻¹ or more, 1700 mW·(cm³)⁻¹ or more, 1800 mW·(cm³)⁻¹ or more, 1900 mW·(cm³)⁻¹ or more, 2000 mW·(cm³)⁻¹ or more, 2100 mW·(cm³)⁻¹ or more, 2200 mW·(cm³)⁻¹ or more, 2400 mW·(cm³)⁻¹ or more, or 2600 mW·(cm³)⁻¹ or more.

Preferably, the fourth volumetric power density is 1500 mW·(cm³)⁻¹ or less. Preferably, the fourth volumetric power density 1600 mW·(cm³)⁻¹ or less, 1700 mW·(cm³)⁻¹ or less, 1800 mW·(cm³)⁻¹ or less, 1900 mW·(cm³)⁻¹ or less, 2000 mW·(cm³)⁻¹ or less, 2100 mW·(cm³)⁻¹ or less, 2200 mW·(cm³)⁻¹ or less, 2400 mW·(cm³)⁻¹ or less, or 2600 mW·(cm³)⁻¹ or less.

### Charge Rates of the Second Embodiment

The charge rate of the charger device battery may be a C-rate of 3C or more, such as a 5C or more, 10C or more, 15C or more, 20C or more, 25C or more, 30C or more, 35C or more, 40C or more, 50C or more, 60C or more or 80C or more with respect to one electron transfer per transition metal per formula unit of working electrode active material.

The discharge rate of the charger device battery is a C-rate of 3C or more, such as a 5C or more, 10C or more, 15C or more, 20C or more, 25C or more, 30C or more, 35C or more, 40C or more, 50C or more, 60C or more or 80C or more with respect to one electron transfer per transition metal per formula unit of working electrode active material.

The charge rate of the charger device battery may be current density of 750 mA·g⁻¹ or more, such as 800 mA·g⁻¹ or more, 850 mA·g⁻¹ or more, 900 mA·g⁻¹ or more, 950 mA·g⁻¹ or more, 1000 mA·g⁻¹ or more, 1050 mA·g⁻¹ or more, 1100 mA·g⁻¹ or more, 1200 mA·g⁻¹ or more, or 1300 mA·g⁻¹ or more.

The discharge rate of the charger device battery may be a current density of 750 mA·g⁻¹ or more, such as 800 mA·g⁻¹ or more, 850 mA·g⁻¹ or more, 900 mA·g⁻¹ or more, 950 mA·g⁻¹ or more, 1000 mA·g⁻¹ or more, 1050 mA·g⁻¹ or more, 1100 mA·g⁻¹ or more, 1200 mA·g⁻¹ or more, or 1300 mA·g⁻¹ or more.

The charge rate of the charger device battery may be gravimetric power density of 1500 mW·g⁻¹ or more, such as 1600 mW·g⁻¹ or more, 1700 mW·g⁻¹ or more, 1800 mW·g⁻¹ or more, 1900 mW·g⁻¹ or more, 2000 mW·g⁻¹ or more, 2100 mW·g⁻¹ or more, 2200 mW·g⁻¹ or more, 2400 mW·g⁻¹ or more, or 2600 mW·g⁻¹ or more.

The discharge rate of the charger device battery may be a gravimetric power density of 1500 mW·g⁻¹ or more, such as 1600 mW·g⁻¹ or more, 1700 mW·g⁻¹ or more, 1800 mW·g⁻¹ or more, 1900 mW·g⁻¹ or more, 2000 mW·g⁻¹ or more, 2100 mW·g⁻¹ or more, 2200 mW·g⁻¹ or more, 2400 mW·g⁻¹ or more, or 2600 mW·g⁻¹ or more.

The charge rate of the charger device battery may be volumetric power density of 1500 mW·(cm³)⁻¹ or more, such as 1600 mW·(cm³)⁻¹ or more, 1700 mW·(cm³)⁻¹ or more, 1800 mW·(cm³)⁻¹ or more, 1900 mW·(cm³)⁻¹ or more, 2000 mW·(cm³)⁻¹ or more, 2100 mW·(cm³)⁻¹ or more, 2200 mW·(cm³)⁻¹ or more, 2400 mW·(cm³)⁻¹ or more, or 2600 mW·(cm³)⁻¹ or more.

The discharge rate of the charger device battery may be a volumetric power density of 1500 mW·(cm³)⁻¹ or more, such as 1600 mW·(cm³)⁻¹ or more, 1700 mW·(cm³)⁻¹ or more, 1800 mW·(cm³)⁻¹ or more, 1900 mW·(cm³)⁻¹ or more, 2000 mW·(cm³)⁻¹ or more, 2100 mW·(cm³)⁻¹ or more, 2200 mW·(cm³)⁻¹ or more, 2400 mW·(cm³)⁻¹ or more, or 2600 mW·(cm³)⁻¹ or more.

The charge rate of the receiver device battery may be less than the discharge rate of the charger device battery. The charge rate may be measured in terms of C-rate, current density, power density, such as gravimetric or volumetric power density.

The charge rate of the receiver device battery may be a C-rate of 3C or less, such as a C-rate 5C or less, 10C or less, 15C or less, 20C or less, 25C or less, 30C or less, 35C or less, 40C or less, 50C or less, 60C or less or 80C or less with respect to one electron transfer per transition metal per formula unit of working electrode active material.

The charge rate of the receiver device battery may be a current density is 750 mA·g⁻¹ or less, such as 800 mA·g⁻¹ or less, 850 mA·g⁻¹ or less, 900 mA·g⁻¹ or less, 950 mA·g⁻¹ or less, 1000 mA·g⁻¹ or less, 1050 mA·g⁻¹ or less, 1100 mA·g⁻¹ or less, 1200 mA·g⁻¹ or less, or 1300 mA·g⁻¹ or less.

The charge rate of the receiver device battery may be a gravimetric power density of 1500 mW·g⁻¹ or less, such as 1600 mW·g⁻¹ or less, 1700 mW·g⁻¹ or less, 1800 mW·g⁻¹ or less, 1900 mW·g⁻¹ or less, 2000 mW·g⁻¹ or less, 2100 mW·g⁻¹ or less, 2200 mW·g⁻¹ or less, 2400 mW·g⁻¹ or less, or 2600 mW·g⁻¹ or less.

The charge rate of the receiver device battery may be a volumetric power density of 1500 mW·(cm³)⁻¹, such as 1600 mW·(cm³)⁻¹ or less, 1700 mW·(cm³)⁻¹ or less, 1800 mW·(cm³)⁻¹ or less, 1900 mW·(cm³)⁻¹ or less, 2000 mW·(cm³)⁻¹ or less, 2100 mW·(cm³)⁻¹ or less, 2200 mW·(cm³)⁻¹ or less, 2400 mW·(cm³)⁻¹ or less, or 2600 mW·(cm³)⁻¹ or less.

Additionally or alternatively, the maximum input power to energy ratio of the charger device battery may be more than the maximum output power to energy ratio. That is, the charge rate of the charger device battery may be more than the discharge rate of the charger device battery. Advantageously, this means the device has a higher uptime, as the time needed to charge the charger device is less than the time over which the device discharges to the receiver battery.

The charge rate of the charger device battery may be more than the discharge rate of the charger device battery. In some embodiments, the charger device battery has a charge rate of 3C or more, such as a 5C or more, 10C or more, 15C or more, 20C or more, 25C or more, 30C or more, 35C or more, 40C or more, 50C or more, 60C or more, and the charger device battery has a discharge rate of less than the charge rate. Preferably, the charger device battery has a charge rate of 60C or more and a discharge rate of less than 60C.

In the method of the invention, the charge rate of the battery may be increased to a maximum charge rate and the discharge rate of the battery is increased to a maximum discharge rate, wherein the maximum charge rate is greater than the maximum discharge rate. In some embodiments, the maximum charge rate is 5C or more and the maximum discharge rate is less than 5C, preferably the maximum charge rate is 10C or more and the maximum discharge rate is less than 10C, more preferably the maximum charge rate is 20C or more and the maximum discharge rate is less than 20C, yet more preferably the maximum charge rate is 60C or more and the maximum discharge rate is less than 60C.

The maximum operable charge rate of the charger device battery may be more than the maximum operable discharge rate of the charger device battery. In some embodiments, the charger device battery has a maximum operable charge rate of 3C or more, such as a 5C or more, 10C or more, 15C or more, 20C or more, 25C or more, 30C or more, 35C or more, 40C or more, 50C or more, 60C or more, and the charger device battery has a maximum operable discharge rate of less than the maximum operable charge rate. Preferably, the charger device battery has a maximum operable charge rate of 60C or more and a maximum operable discharge rate of less than 60C.

### Charging Device

In a second aspect there is provided a charging device, for charging a receiver battery, the charging device comprising:
a battery, wherein the battery comprises an electrochemical cell;
a power connector, to separably electrically connect to the receiver battery;
a charging engine in electrical communication with the battery and the power connector, wherein the charging engine controls the rate of discharge of the battery; and
a controller in communication with the battery and the charging engine, for adjusting the discharging rate of the battery in response to data on the condition of the battery, to increase the discharge rate, wherein the discharge rate is increased to a rate of 3C or more.

In some embodiments, the battery comprises an electrochemical cell having a working electrode active material comprising a niobium-containing metal oxide.

The charging device may be used in a method of charging, as described above.

Generally, the charging device includes a battery, which is dischargeable by a charging engine through a power connector, and where the charging engine controls the discharge rate. The power connector is separably connectable to a receiver battery (e.g. in a receiver device) and discharging of the battery to the power connector charges the receiver battery. The controller signals to the charging engine how fast to discharge the battery in response to data on the condition of the battery sent to the controller. The discharge rate may be increased to within the limits of the battery in order to maximise the rate of discharge for the battery and the rate of charging of the receiver battery, without damaging the battery or compromising the safety of discharging.

### Battery

The battery of the charging device is a battery comprising an electrochemical cell. The electrochemical cell typically has a working electrode active material comprising a metal oxide, preferably a niobium-containing metal oxide. Alternatively, the electrochemical cell may have a working electrode active material comprising particles of graphite, silicon, SiOₓ (where x is from 0 to 2), or LTO.

The battery is in electrical communication with the charging engine and power connector, as described below. The battery is also in communication with the controller. Data on the condition of the battery is sent to the controller, as described for the data sending step above.

The battery refers to a plurality of electrochemical cells. The electrochemical cell comprises a working electrode. The working electrode may be an anode or cathode during a discharge step, for example in a lithium ion battery. Typically, the working electrode is the anode during a discharge step.

The electrochemical cell typically further comprises a counter electrode and an electrolyte.

The electrochemical cell may comprise a current collecting plate.

The electrochemical cell may be a lithium ion cell.

The counter electrode may be an anode or cathode during a discharge step, for example in a lithium ion battery. The counter electrode is typically the cathode during a discharge step.

Where there is a plurality of cells, these may be provided in series or parallel, or a mixture of cells in series and in parallel.

The battery may comprise any number of cells and may be made up of one or more sub-batteries. The battery may be a modular system such that sub-batteries are replaceable.

The electrochemical cell may have a capacity retention of at least 70%, 75%, 80%, 85%, 90%, 95%, 96%, 97%, 98%, 99%, or 100% at 10C maintained over at least 50, 100, 150, 200, 250, 300, 400, 500, 600, 700, 800, 900, 1,000, 1,200, 1,500, 1,800, or 2,000 cycles.

The electrochemical cell may have a capacity retention of at least 70%, 75%, 80%, 85%, 90%, 95%, 96%, 97%, 98%, 99%, or 100% at 20C maintained over at least 50, 100, 150, 200, 250, 300, 400, 500, 600, 700, 800, 900, 1,000, 1,200, 1,500, 1,800, or 2,000 cycles.

Preferably, the maximum operable discharge rate of the charger battery is higher than the higher maximum operable charge rate of the receiver battery. The maximum operable discharge rate of the battery is the maximum rate of discharge where the capacity retention is at least 70%, 75%, 80%, 85%, 90%, 95%, 96%, 97%, 98%, 99%, or 100% maintained over at least 50, 100, 150, 200, 250, 300, 400, 500, 600, 700, 800, 900, 1,000, 1,200, 1,500, 1,800, or 2,000 cycles. Preferably the maximum operable discharge rate is 3C or more, preferably 5C or more, more preferably 10 C or more.

In some embodiments, the maximum operable discharge rate is 3C or more, where the capacity retention is at least 70% over 1,000 cycles, preferably 5 C or more, where the capacity retention is at least 70% over 1,000 cycles, more preferably 10 C or more where the capacity retention is at least 70% over 1,000 cycles.

In some embodiments, the maximum operable discharge rate is 3C or more, where the capacity retention is at least 80% over 1,000 cycles, preferably 5 C or more, where the capacity retention is at least 80% over 1,000 cycles, more preferably 10 C or more where the capacity retention is at least 80% over 1,000 cycles.

In some embodiments, the maximum operable discharge rate is 3C or more, where the capacity retention is at least 90% over 1,000 cycles, preferably 5 C or more, where the capacity retention is at least 90% over 1,000 cycles, more preferably 10 C or more where the capacity retention is at least 90% over 1,000 cycles.

The electrochemical cell may be regarded as fully charged when the voltage passes a threshold value. For example, an electrochemical cell comprising a lithium metal anode and a niobium tungsten oxide cathode may be regarded as fully charged when the voltage rises above a practicable level, such as where the voltage rises above 2.0 V against Li/Li⁺, such as above 2.25 V or above 2.5 V.

The electrochemical cell may be regarded as fully discharged when the voltage passes a threshold value. For example, an electrochemical cell comprising a lithium metal anode and a niobium tungsten oxide cathode may be regarded as fully discharged when the voltage drops below a practicable level, such as where the voltage drops below 1.5 V against Li/Li⁺, such as below 1.25 V or below 1.0 V.

The electrochemical cell may also refer to a battery comprising a plurality of electrochemical cells. The electrochemical cells may be connected in series or in parallel.

Additionally or alternatively, the charger device battery may have an energy density of 100 Wh/L or more, preferably 150 Wh/L or more, more preferably 200 Wh/L or more.

### Working Electrode

The working electrode may be an anode or cathode during a discharge step, for example in a lithium ion battery. Preferably, the working electrode is the anode during a discharge step. The working electrode is electrically conductive, and is electrically connectable to a counter electrode, for example within an electrochemical cell.

In some embodiments, the working electrode comprises a niobium-containing metal oxide. A niobium-containing metal may be selected from Nb₂O₅ polymorphs, NbO₂, Nb₂O₃ or combinations thereof.

The niobium-containing metal oxide may be a mixture (for example, an amorphous mixture) of a niobium oxide and an additional metal oxide. Suitable additional metal oxides include titanium oxide, hafnium oxide, tantalum oxide or aluminium oxide.

The niobium-containing metal oxide may be a compound (for example, having a crystalline structure) of a niobium oxide and an additional metal oxide. Suitable niobium-containing metal oxides include niobium tungsten oxide (for example Nb₁₆W₅O₅₅ or Nb₁₈W₁₆O₉₃), a titanium niobium oxide (for example TiNb₂O₇), a niobium molybdenum oxide (for example Nb₂Mo₃O₁₄), or combinations thereof.

Suitable niobium tungsten oxides include Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, or Nb₂W₁₅O₅₀ or combinations thereof.

In some embodiments, the working electrode comprises a niobium-containing metal oxide material having a molar ratio of Nb₂O₅ to WO₃ from 6:1 to 1:15. Preferably, the molar ratio of Nb₂O₅ to WO₃ in the working electrode is from 8:5 to 11:20. More preferably, the molar ratio of Nb₂O₅ to WO₃ in the working electrode is 8:5 or 9:16.

In some embodiments the working electrode active material comprises Nb₁₆W₅O₅₅, Nb₁₈W₈O₆₉, Nb₂WO₈, Nb₁₈W₁₆O₉₃, or Nb₂₂W₂₀O₁₅, or combinations thereof. Preferably the working electrode comprises Nb₁₆W₅O₅₅ or Nb₁₈W₁₆O₉₃, or combinations thereof.

In some embodiments, the working electrode comprises graphite, Si, SiOₓ (where x is typically from 0 to 2), LTO, or a mixture thereof. In some embodiments, the working electrode consists essentially of graphite Si, SiOₓ (where x is typically from 0 to 2), or lithium titanate (LTO). Preferably, the working electrode comprise these compounds (e.g. graphite) in particulate form. The size of the particles of the working electrode may be known, or it may be determined using standard techniques such as SEM. The particles of the working electrode may have a primary particle size of at least 1 μm. The primary particle size is the size of the individual crystallite. It is the smallest identifiable subdivision in a particulate system. For example, the particles may have a primary particle size of at least 2 μm, 3 μm, 4 μm, 5 μm or 10 μm. Preferably the primary particle size is less than 100 μm, 50 μm, 30 μm, 20 μm or 10 μm. The particular particle size may result in higher lithium diffusion coefficients, which allow for high discharge rates of the electrochemical cell.

The graphite particles may agglomerate to form secondary particles. Typically, the graphite particles have an agglomerate (secondary) particle size of at least 5 μm. More preferably, the agglomerate graphite particles have an agglomerate particle size of at least 10 μm, 15 μm, 20 μm, 25 μm or 30 μm.

Optionally, the working electrode comprises a mixture of niobium tungsten oxide and an additional active material. The additional active material may be an additional metal oxide.

For example, the working electrode may comprise a mixture of niobium tungsten oxide and an additional active material selected from lithium titanate (LTO; Li₄Ti₅O₁₂), titanium niobium oxides (for example TiNb₂O₇), titanium tantalum oxides (for example TiTa₂O₇), tantalum molybdenum oxides (for example Ta₈W₉O₄₇) and niobium molybdenum oxides (for example Nb₂Mo₃O₁₄).

Graphite may also be used as an additional active material. A working electrode comprising a mixture of niobium tungsten oxide and graphite is cheaper to produce while maintaining the beneficial properties outlined above.

Preferably, the working electrode comprises a mixture of niobium tungsten oxide and LTO. The ratio of niobium tungsten oxide to LTO may be from 95:5 to 5:95 by weight. For example, the ratio may be from 90:10 to 10:90 by weight, from 80:20 to 20:80 by weight, from 70:30 to 30:70 by weight, from 60:40 to 40:60 by weight or the ratio of niobium tungsten oxide to LTO may be 1:1 by weight.

Preferably, the working electrode consists essentially of niobium tungsten oxide and an additional active material. For example, the working electrode consists essentially of a mixture of niobium tungsten oxide and LTO.

Typically, the working electrode does not have a porous nor hierarchical structure. For example, the electrode material may have a specific surface area of less than 20 m²·g⁻¹, less than 10 m²·g⁻¹, less than 5 m²·g⁻¹, less than 3 m²·g⁻¹, less than 2 m²·g⁻¹ or less than 1 m²·g⁻¹. The specific surface area of the electrode material may be known, or it may be determined using standard techniques such as N₂ adsorption isotherm analysis and Brunauer-Emmett-Teller (BET) theory.

Alternatively, the working electrode may have a porous structure. For example, the working electrode may have a specific surface area of at least 50 m²·g⁻¹, at least 60 m²·g⁻¹, 70 m²·g⁻¹, 80 m²·g⁻¹, 90 m²·g⁻¹, 100 m²·g⁻¹, 150 m²·g⁻¹, 200 m²·g⁻¹, 300 m²·g⁻¹, or 400 m²·g⁻¹.

The working electrode may have a pore volume of at least 0.1 cm³·g⁻¹, at least 0.2 cm³·g⁻¹, at least 0.4 cm³·g⁻¹, at least 0.5 cm³·g⁻¹, at least 0.7 cm³·g⁻¹, at least 0.8 cm³·g⁻¹, at least 0.9 cm³·g⁻¹, at least 1.0 cm³·g⁻¹, at least 1.5 cm³·g⁻¹ or at least 2.0 cm³·g⁻¹. The pore volume of the electrode material may be known, or it may be determined using standard techniques such as N₂ adsorption isotherm analysis and Barrett-Joyner-Halenda (BJH) theory.

The porous working electrode may have an average pore size (largest cross section) of at least 1 nm, at least 5 nm, at least, 10 nm, at least 20 nm, at least 30 nm, at least 40 nm, at least 50 nm or at least 100 nm.

The porous working electrode may have a macroporous structure. Thus, the porous working electrode may contain pores having a largest cross section of at least 200 nm, at least 500 nm, at least 1 μm, or at least 5 μm.

The pore size of the electrode material may be known, or it may be determined using standard techniques such as scanning electron microscopy (SEM). The working electrode may additionally comprise porous carbon, such as porous reduced graphene oxide.

Electrodes comprising porous carbon are generally light and conductive, and can provide large pore volumes, which can allow rapid transport of lithium ions and electrons to the active materials. They may also increase the electrochemical capacity of the working device.

The working electrode may additionally comprise reduced graphene oxide, Ketjen black or Super P carbon. Alternatively, the working electrode may have a hierarchical structure. For example, the working electrode may additionally comprise hierarchical reduced graphene oxide (rGO).

Preferably, the working electrode comprise a niobium tungsten oxide in particulate form. The size of the niobium tungsten oxide particles of the working electrode may be known, or it may be determined using standard techniques such as SEM. The niobium tungsten oxide particles of the working electrode may have a primary particle size of at least 1 μm. The primary particle size is the size of the individual crystallite. It is the smallest identifiable subdivision in a particulate system. For example, the niobium tungsten oxide particles have a primary particle size of at least 2 μm, 3 μm, 4 μm, 5 μm or 10 μm, such as from 2 to 100 μm, preferably from 5 to 50 μm, more preferably from 10 to 20 μm.

The individual niobium tungsten oxide particles may agglomerate to form secondary particles. Typically, the niobium tungsten oxide particles have an agglomerate (secondary) particle size of at least 5 μm. More preferably, the niobium tungsten oxides have an agglomerate particle size of at least 10 μm, 15 μm, 20 μm, 25 μm or 30 μm, such as from 10 to 200 μm, preferably from 20 to 100 μm, more preferably from 30 to 50 μm.

Where present, the additional active material may be in particulate form. The size of the additional active material particles may be known, or it may be determined using standard techniques such as SEM.

Preferably, the additional active material particles have a primary particle size of 1 μm or less. For example, the additional active material particles have a primary particle size of 800 nm or less, 750 nm or less, 700 nm or less, 600 nm or less, 500 nm or less, 400 nm or less, 300 nm or less, 200 nm or less or 150 nm or less. Particulate lithium titanate typically has a particle size within this range.

Electrodes comprising a mixture of niobium tungsten oxide and an additional active material having particle sizes within the ranges described above can be charged and discharged at very high C-rates and at very high charge densities.

To improve conductivity at the working electrode, a conductive carbon material (e.g., carbon black, graphite, nanoparticulate carbon powder, carbon fiber and/or carbon nanotubes) is typically admixed with the working electrode material. Alternatively, the conductive carbon material may be coated onto the working electrode material. In one embodiment, the working electrode comprises porous carbon, such as porous reduced graphene oxide, which may wrap the larger niobium oxides particles.

Typically, the working electrode contains 1-5% by weight of binders.

The electrode may consist essentially of niobium tungsten oxide.

Alternatively, the working electrode is admixed with a binder or adhesive. Some examples of binders or adhesives include PVDF, PTFE, CMC, PAA, PMMA, PEO, SBR and co-polymers thereof.

The working electrode is typically fixed to a current collector, such as a copper or aluminum collector, which may be in the form of a plate.

In some embodiments the working electrode comprising a particulate niobium tungsten oxide using a standard electrode configuration of 8:1:1 active material/carbon/binder with a 2-3 mg·cm² loading of active material and a 1.27 cm² electrode area against a lithium counter electrode and using 1.0 M LiPF₆ in ethylene carbonate/dimethyl carbonate as electrolyte. Under these conditions, the cell may maintain a capacity of up to 150 mA·h·g⁻¹ at 10C for 1000 cycles, and a capacity of up to 125 mA·h·g⁻¹ at 20C for 750 cycles.

Under these conditions the niobium tungsten oxides have a solid-state lithium diffusion coefficient (D_{Li}) of 10⁻¹³ to 10⁻¹² m²·s⁻¹ at 298 K. This corresponds to a characteristic diffusion length of ca. 10 μm for a 1-minute discharge.

In some embodiments the working electrode comprises a niobium molybdenum oxide. The working electrode is electrically conductive, and is electrically connectable to a counter electrode, for example within an electrochemical cell. Typically, the working electrode comprises a molar ratio of Nb₂O₅ to MoO₃ of from 6:1 to 1:3. Preferably, the molar ratio of Nb₂O₅ to MoO₃ in the working electrode is 1:3. Preferably, the working electrode comprises a niobium molybdenum oxide selected from Nb₂Mo₃O₁₄, Nb₁₄Mo₃O₄₄ or Nb₁₂MoO₄₄. More preferably, the working electrode comprises Nb₂Mo₃O₁₄.

The working electrode may not have a porous nor hierarchical structure. The working electrode may have a specific surface area, pore volume and average pore size as described above. Typically, the working electrode comprise a niobium molybdenum oxide in particulate form. The niobium molybdenum oxide particles of the working electrode may have a primary or agglomerate particle size as described above.

### Counter Electrode

The electrochemical cell typically comprises a counter electrode. The counter electrode may be an anode or cathode during a discharge step, for example in a lithium ion battery.

Preferably the counter electrode is the cathode during a discharge step.

A plurality of battery cells refers to one or more electrochemical cells, as described herein.

In addition to the working electrode, an electrochemical cell comprises a counter electrode and an electrolyte, and optionally a separator, such as a microporous polyethylene film, between the working electrode and counter electrode.

Suitable materials for the counter electrode include lithium-containing or lithium-intercalated material, such as a lithium metal oxide, wherein the metal may be a transition metal such as Co, Fe, Ni, V, or Mn, or combination thereof. Some examples of counter electrode materials include lithium cobalt oxide (LiCoO₂) lithium nickel manganese cobalt oxide (NMC, LiNiMnCoO₂, e.g., LiNi_{0.6}Co_{0.2}Mn_{0.2}O₂), lithium vanadium fluorophosphate (LiVPO₄F), lithium nickel cobalt aluminium oxide (NCA, LiNiCoAl₂), lithium iron phosphate (LFP, LiFePO₄) and manganese-based spinels (e.g. LiMn₂O₄). In one embodiment, the counter electrode is substantially free of binders. In an alternative embodiment, the counter electrode is admixed with a binder or adhesive. Some examples of binders or adhesives include PVDF, PTFE, CMC, PAA, PMMA, PEO, SBR and co-polymers thereof. The counter electrode may be fixed to a current collecting substrate, such as an aluminium plate.

### Electrolyte

The electrolyte comprises lithium salts, such as lithium (bis(trifluoromethane)sulfonimide (LiTFSI), LiPF₆, LiBF₄, LiClO₄, lithium triflate (LiTF), or lithium bis(oxalate)borate (LiBOB). The electrolyte may be a liquid electrolyte, such as a liquid at ambient temperature, for example at 25° C. The electrolyte may be a non-aqueous electrolyte. The electrolyte may comprise a polar aprotic solvent, such a cyclic or linear carbonate, such as ethylene carbonate, dimethyl carbonate, or ethyl methyl carbonate.

Suitable solvents include carbonate solvents. For example propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

Suitable solvents also include sulfone solvents. For example methyl sulfone, ethyl methyl sulfone, methyl phenyl sulfone, methyl isopropyl sulfone (MiPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), di phenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl) ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone).

Suitable solvents also include silicon-containing solvents such as a siloxane or silane. For example, hexamethyldisiloxane (HMDS), 1,3-divinyltetramethyldisiloxane, the polysiloxanes, and polysiloxane-polyoxyalkylene derivatives. Some examples of silane solvents include methoxytrimethy Isilane, ethoxytrimethy Isilane, dimethoxydimethylsilane, methyltrimethoxysilane, and 2-(ethoxy)ethoxytrimethylsilane.

Typically, an additive may be included in the electrolyte to improve performance. For example vinylene carbonate (VC), vinyl ethylene carbonate, allyl ethyl carbonate, t-butylene carbonate, vinyl acetate, divinyl adipate, acrylic acid nitrile, 2-vinyl pyridine, maleic anhydride, methyl cinnamate, ethylene carbonate, halogenated ethylene carbonate, α-bromo-γ-butyrolactone, methyl chloroformate, 1,3-propanesultone, ethylene sulfite (ES), propylene sulfite (PS), vinyl ethylene sulfite (VES), fluoroethylene sulfite (FES), 12-crown-4 ether, carbon dioxide (CO₂), sulfur dioxide (SO₂), and sulfur trioxide (SO₃).

The electrochemical cell may also include a separator, such as a solid porous membrane positioned between the working and counter electrodes. The solid porous membrane may partially or completely replace the liquid electrolyte. The solid porous membrane may comprise a polymer (e.g., polyethylene, polypropylene, or copolymer thereof) or an inorganic material, such as a transition metal oxide (e.g., titania, zirconia, yttria, hafnia, or niobia) or main group metal oxide, such as silicon oxide, which can be in the form of glass fiber.

The solid non-porous membrane may comprise a lithium-ion conductor. For example, LLZO (garnet family), LSPO (LISICON family), LGPS (thio-LISICON family), LATP/LAGP (NASICON family), LLTO (perovskite family) and phosphide/sulfide glass ceramics.

### Power Connector

The charging device includes a power connector. The power connector is separably connectable with the receiver battery. Any suitable power connectors may be used, provided they allow electrical communication between the charging device and an external device (e.g. a receiver device battery or a power supply). The power connector may include a DC fast charging inlet of the type typically used for charging the batteries of EVs. This provides DC power to the charging device from, for example, a DC fast charging station. An alternative or additional power connector is an AC power input that could be used to slow charge the charging device from a household power outlet or low-power AC charging station. The DC power input could also be arranged to provide AC power from a low-power AC charging station as well as or instead of DC power.

Examples of suitable power connectors include domestic plug and socket connections, such as BS 1363 three-pin (rectangular) standard, BS 546 three-pin (round), CEE 7 two-pin standard, China GB 2099.1-2008 and GB 1002-2008 standards, IEC 60906-2 two-pin US standards, RAM 2073 and 2071 (Type I), S/NZS 3112 (Type I). Further examples of suitable connections include EV charger plug and socket connections, such as Type 1 single-phase AC, Type 2 triple-phase AC, CCS (combined charging system) or CHAdeMO.

The power connector is for connecting to a receiver battery (e.g. a receiver device battery) in order to charge the receiver battery from the charging device. When the power connector is for connecting to a receiver battery it may be referred to as a power output. The power output is typically for discharging the battery.

The power output may be any suitable means of delivering power from the charging device to a receiver device, by discharging the battery of the charging device. The power output is connectable to the receiver device by any suitable connection, such as by a conventional charging cable or inductive charging.

The power connector may also be for connecting to a power supply, for charging the charging device battery. When the power connector is for connecting to a power supply it may be referred to as the power input. The power input is typically for charging the battery. The power input may be any suitable means of supplying power to the charging device, to charge the battery of the charging device. Typically, the power input is connectable to mains electricity, such as a domestic power supply, a domestic car charger (e.g. a “wall box”) or a EV charging station.

Any suitable power input or power output can be used, such AC power or DC power. The input power may be 3-phase AC power (e.g. from a domestic power supply) or may be a DC direct connection (e.g. from a EV charging station). Preferably the power output is DC power.

In some embodiments the power connector includes a separate power input and power output connector. Preferably, the power output is a DC connector. Preferably the power input may be an AC or DC connector, more preferably the power input is a DC connector. The power input or output may be a switchable AC and DC connector, such as a CCS connector.

In some embodiments the power connector includes a unitary power input and power output. In this embodiment, a single power connector is used for charging and discharging the battery. Preferably, the unitary power input and power output is a switchable AC and DC connector. The charging engine may be bidirectional.

In some embodiments the power connector comprises a sensor, for detecting if a power supply and/or a receiver battery is connected. Any suitable sensor may be used, such as an optical sensor or a voltmeter/ohmmeter across the power connector connectors. Typically, the sensor is in communication with the controller, for signaling to the controller when something is connected to the power connector.

In some embodiments the power connector comprises a data connector, for communicating with a power supply or a receiver battery. Any suitable data connector may be used, which can transfer data to and/or from the power controller of the charging device to a connected power supply or receiver battery.

### Charging Engine

The charging device includes a charging engine.

The charging engine is in electrical communication with the battery and the power connector. The charging engine is in communication with the controller. Typically, the charging engine controls the rate of discharge and/or charge of the battery to/from the power connector. The rate is changed based on signals from the controller.

The charging engine may send data to the controller, such as data on the condition of the battery or the rate of discharge (or charge). The data is as described for the data sending step, above.

The charging engine may comprise a means of measuring data. Any suitable means of measuring the data may be used. For example, voltage may be measured using a voltmeter, current by an ammeter, resistance by an ohmmeter, temperature by a thermocouple, isolation resistance by a high input impedance ohmmeter, and state of charge, state of balancing and power availability by voltmeter or by an ammeter (e.g. by “coulomb counting”).

The charging engine may send the data to the controller by any suitable means, such as by electronic communication.

The data may be processed in the measurement device of the charging engine and sent to the controller. Alternatively, unprocessed data may be sent to the controller from the charging engine, and the data may be processed in the controller.

The charging engine may be included in the power input and the power output. In some embodiments separate charging engines are used for the power input and the power output. In other embodiments the same charging engine is used for both the power input and the power output, and preferably the charging engine is bidirectional.

The charging engine may include a gate driver. Suitable gate drives typically include a level shifter and an amplifier.

The charging engine may include a power conditioning system. Suitable power conditioning systems are known in the art. The power condition system may include a surge protector, frequency corrector or voltage corrector. The power conditioning typically smooths or decreases variability in the power.

The charging engine may include an inverter (i.e. which changes direct current (DC) to alternating current (AC)) or converter (i.e. AC to DC, or DC to DC). Suitable inverters or converters are known in the art. Typically, a DC-DC converter is comprised in the charging engine. Suitable DC-DC converters are known in the art, such as buck, boost, or a buck-boost converter. Suitable AC-AC converters are known in the art, such as transformers.

DC power (e.g. from a DC fast charger) may be passed through a power conditioner. This power conditioner may carry out appropriate power conditioning, converting the voltage received from the power connector as appropriate and accordingly may incorporate or be connected to a boost, buck, or buck-boost DC-DC converter in order to carry out power conditioning.

AC power (e.g. from a domestic power supply) may be passed through an AC/DC charging engine to charge the battery. The AC/DC charging engine carries out any required conversion and power conditioning.

In some embodiments, the charging engine is bidirectional. The charging engine may be used to condition the input and output of power as described herein.

In some embodiments the charging engine can be bypassed, so the power connector is connected directly to the battery. Certain parts of the charging engine may be bypassed, such as the gate drive, power conditioner, converter or inverter. The bypass may be controllable, so that the controller can control which parts of the charging engine are used and which are bypassed. For example, when the input is a DC input the controller may bypass a converter in the charging engine, or when the output is DC the controller may bypass an inverter in the charging engine.

The charging engine may also adjust the discharge rate (or charge rate) of individual or groups of electrochemical cells comprised in the battery, thereby balancing the electrochemical cells in the battery.

The charging engine may also send data about the state of charge (e.g. voltage) of individual or groups of electrochemical cells comprised in the battery. This data may then be used by the controller to balance the cells in the battery, which reduces the amount of overvoltage or undervoltage of any individual cell, which in turn reduces potential damage to the cells.

The charging engine may further comprise a battery management system (BMS). The BMS is typically in electronic communication with the battery. The BMS may be part of the battery. The BMS typically controls the discharge and charging individual or groups of electrochemical cells, the balancing of the cells, and measures data about the cells and/or the charging engine. The BMS may include similar components as the charging engine, as described herein.

### Controller

The charging device includes a controller. The controller is in communication with the battery, and receives data sent about the condition of the battery. The controller is in also in communication with the charging engine, and may receive data about the condition of the battery. The controller signals to the charging engine to control the discharging rate of the battery in response to data from the battery and the charging engine. The controller increases the discharge rate to a rate of 3C or more.

The controller receives data sent from the battery and charging engine. The data is that which can be used to indicate the condition of the battery during discharge. The data may be used to determine if the battery can be discharged at a higher rate.

In some embodiments, the data is selected from the list comprising at least one of battery voltage, battery temperature, battery isolation resistance, and discharge current, state of charge of the electrochemical cells, state of balancing of the electrochemical cells, and power availability of the battery.

In some embodiments, the data comprises voltage, current, and temperature.

The data and frequency of data sending is as described for the data sending step, above.

The controller responds to the data by adjusting the discharge rate (or the charge rate). Typically, the controller compares the data on the condition of the battery against an acceptable range and determines if the discharge rate should be increased or decreased. If the data is inside the acceptable range the rate of discharge is increased, or if the data is outside of the acceptable range the rate of discharge is decreased. The controller may signal to the charging engine whether to increase or decrease the rate of discharge.

The controller increases the discharge rate to a rate of 3C or more. Preferably, the controller increases the discharge rate to a rate of 5C or more, preferably 10C or more, more preferably 20 C or more. Alternatively, the controller increases the discharge rate to a power density of 1500 mW·g⁻¹ or more, preferably 1800 mW·g⁻¹ or more, more preferably 2100 mW·g⁻¹ or more.

In the first embodiment, the discharge rate of the battery is increased to a discharge rate which is lower than the charge rate of a receiver battery.

In the second embodiment, the discharge rate of the battery is increased to a discharge rate which is higher than the charge rate of a receiver battery.

The rate of charge and discharge are as described in the charge and discharge rate section, above.

The controller is configured to carry out the functions as described for the rate adjustment step, above. The acceptable ranges are as described above, for the rate adjustment step.

The controller may start and stop charging and discharging of the charging device battery.

The controller may receive a signal to start and/or stop charging and discharging.

The signal may be from the receiver device, a user interface, or another input. The controller may detect when a connection is made to the power input or output, in order to start charging or discharging. The controller may detect when a connection is removed from the power input or output, in order to stop charging or discharging.

The controller may receive data sent from a receiver battery. The data may be the same as that sent to the controller from the battery of the charging device. The controller may receive data then signal to the charging engine how to output power, based on the data from the receiver.

The controller may receive data sent from the power supply. The data may include if the power supply provides AC or DC power, the voltage of the power, the frequency (for AC power), the current of the power. The controller may then signal to the charging engine how to treat the input power, based on the data from the power supply.

The controller may also receive data about the state of charge (e.g. voltage) of individual or groups of electrochemical cells comprised in the battery. This data may then be used by the controller to balance the cells in the battery, which reduces the amount of overvoltage or undervoltage of any individual cell, which in turn reduces potential damage to the cells. The controller typically balances the cells while the battery is discharging, which can improve the discharge rate of the battery as the stress on the battery is reduced due to the improved balancing of the cells.

### Use

In a third aspect there is provided a use of the device of the second aspect for charging an electric vehicle, an uninterrupted power supply or a mobile computing device.

An electric vehicle (EV) may include road vehicle, such as an automobile, moped or truck; a rail vehicle, such as a train or a tram; an electric bicycle (e-bike), a drone, an electric aircraft, and an electric or hybrid boat. Preferably the use of the device of the second aspect is for charging a road vehicle, more preferably an automobile.

Similarly, the use of the device of the second aspect may be for charging batteries in power tools such as powered drills or saws; garden tools such as lawnmowers or grass trimmers; home appliances such as toothbrushes or hairdryers; medical devices such as automated surgical robots or pacemakers, or mobile computing devices such as laptops, tablets and mobile phones. Preferably the use of the device of the second aspect is for charging mobile computing devices such as laptops, tablets and mobile phones.

The use of the device of the second aspect may also be for charging an uninterrupted power supply or a power grid management system.

### DETAlLED DESCRIPTION OF FIGURES

FIG. 1a shows a Charger [11] connected to a Receiver [12]. The connection [17] may be wired or wireless, for example using a conventional charging cable or inductive “wireless charging” pad. Each device [11, 12] also includes a controller [15, 16], which monitors the battery [13, 14] and controls charging and discharging as appropriate and as further described below. Both devices [11, 12] may have further components or connections which for the purposes of clarity are not shown here.

For example, the Charger [11] may be a wall charger with an AC mains connection such as a three-pin plug connector in accordance with standard BS 1363, monitoring LEDs, and multiple charging outputs, as well as an internal battery [13] which is slowly charged with grid power, i.e., mains electricity, for example at a rate below 0.1C (i.e. requiring at least ten hours to charge from 0% state of charge to 100% state of charge). Slow charging can take place through slow-charging connections such as USB and the use of a battery [13] in the Charger [11] allows charging before the power stored in the Charger's battery [13] is required, for example at times of day when energy prices are lower or through solar panels or another method of power generation that does not constantly provide power.

Accordingly, the Charger [11] is shown to have a fully-charged internal battery [13] and the Receiver [12] is shown to have a depleted internal battery [14] which is charged through a transfer of power from the battery [13] of the Charger [11].

An example use of this type of system is a tool battery for an industrial device or tool, such as a drill. In this example, the tool battery, acting as the Receiver [12], can be connected to the Charger [11] and charged extremely rapidly, rather than having to wait multiple hours for charging to complete as is the case with conventional rechargeable battery systems. This increases the useable time of the drill and reduces the requirement for redundant batteries.

In another example, the Charger [11] could be a backup battery, such as have become common to provide backup power for personal devices such as smartphones, wireless headphones or earbuds, or other such small, portable electronic devices. Such backup batteries are conventionally charged over multiple hours via USB, though backup batteries with integral solar panels exist. Conventionally, for use the backup battery must be connected to the personal device, also commonly via USB, and the two devices must be carried together until charging is complete, causing significant inconvenience to the user. If the backup battery acts as a Charger [11] in the system shown in FIG. 1a while the personal device acts as a Receiver [12], recharging could take place extremely quickly, increasing user convenience significantly.

A third example embodiment of the system shown in FIG. 1a is a charging station for an electric vehicle (EV). Conventionally, charging stations are connected directly to the electricity grid and draw power when required for charging. This limits the total power output of the charging station to that provided by the grid moment to moment, thereby limiting the number of EVs that can be connected at any one time; can cause power spikes; and reduces the capability of charging stations to take advantage of cheaper power tariffs at different times of day, as well as renewable power sources which may not constantly provide power such as solar panels or wind turbines. Furthermore, conventional charging is slow; even so-called “fast-charging” of an EV currently requires a minimum of half an hour. In a system such as that shown in FIG. 1a, the charging station, acting as a Charger [11] could incorporate a battery [13] which is charged during times of reduced power demand, cheaper power supply, or supply from renewable sources and then the internal battery of the EV, which acts as the Receiver [12], could be rapidly charged from the battery [13] in the charging station. In a fourth example embodiment of the system shown in FIG. 1a, the Charger [11] could be a fast-charging device connected to any other source of electrical power such as a fuel cell, conventional diesel-powered generator, nuclear reactor, or similar. Such sources of power are not capable of fast charging by themselves, so the battery in the Charger [11] of a system according to the invention could be used to provide fast charging to the Receiver [12], which could be a personal electronic device, EV, industrial machine, etc.

Devices such as the tool battery, personal device, and EV described in the above embodiments are examples of mobile devices, which are portable and can be brought to a source of power. It is therefore more convenient to bring a Receiver [12] which is a mobile device to the Charger [11] for charging. Conversely, devices such as industrial machines or scientific equipment which cannot be moved and must have a power source brought to them to charge any internal battery can be described as static devices. A Receiver [12] which is a static device can most conveniently be charged using a Carrier [18], which can be charged at the Charger [11] and taken to the Receiver [12] and will be described further in FIG. 1b.

Similarly, in a system such as that shown in FIG. 1a, the Charger [11] may also be a static or mobile device. In this case, a device such as the backup battery described in the second of the above embodiments is a mobile device, which is portable and can be used to provide charging in any location, taking full advantage of the fact that it includes an internal battery. A device such as a wall charger as suggested by the first embodiment or a charging station such as that described in the third embodiment is a static device, since it is difficult or impossible to move it to the Receiver [12] to act as a source of power. A Charger [11] which is a mobile device may also be embodied as a Carrier [18], as further described in FIG. 1b.

FIG. 1b shows a Charger [11] connected [17a] to a Carrier [18], which is in turn connected [17b] to a Receiver [12]. As in FIG. 1a, the connections [17] may be any type of connection capable of carrying or inducing electrical charge, whether wired or wireless.

All three devices [11, 12, 18] have internal batteries [13, 14, 19] which are operable to charge and discharge at a high C-rate, where the C-rate increases through the system. I.e., the Carrier [18] is capable of being charged at a higher C-rate than the Charger [11] is capable of charging it, and in turn the Receiver [12] is capable of being charged at a higher C-rate than the Carrier [18] is capable of charging it. This ratio of C-rates potentially allows for extremely fast nominal charging rates throughout the system. Similarly to the Charger [11] and Receiver [12] shown in FIG. 1a, the Charger [11], Carrier [18], and Receiver [12] of FIG. 1b are all equipped with battery controllers [15, 16, 110] to monitor their respective internal batteries [13, 14, 19] and control the process of charging and discharging as appropriate.

This chain can be extended with multiple Carriers [18].

An example embodiment of this system includes a mains-connected charger with an internal battery, which is an example of a Charger [11] that is a static device. This charger is used to charge portable battery packs which are examples of Carriers [18] which in turn can be used to charge the internal battery or batteries [14] of a piece of industrial or scientific equipment that cannot easily be attached to mains electricity, which is an example of a Receiver [12] that is a static device. Naturally, this can also be extended to one of the example use cases previously mentioned.

Preferably the battery [13] in the Charger [11] is comprised of cells that have a working electrode (anode during the discharge step) comprising a niobium-based material, such as a niobium oxide, or niobium metal oxide, but this is not necessary and the battery [13] can be any chargeable battery including, but not limited to, lead-acid, nickel metal hydride, or lithium-ion.

The battery [14/19] in the device which is being charged—either the Carrier [18] or the Receiver [12]—is comprised of cells that have a working electrode (anode during the discharge step) comprising a niobium-based material, niobium oxide, or niobium metal oxide, allowing for a high C-rate due to the electrochemical properties of such materials, as described in WO 2019/234248. In all cases, the counter electrode of the battery (cathode during the discharge step) [13, 14, 19] may be comprised of any suitable material.

The use of a niobium-based material in the working electrodes (anode during the discharge step) of both or all batteries [13, 14, 19] allows the voltage profile on discharge of the battery [13/19] in the Charger [11] or Carrier [18] to be symmetric with the voltage profile on charge of the battery [19/14] in the Carrier [18] or Receiver [12]. Voltage profile is based on the relationship between the open circuit voltage (OCV) of the battery, meaning the potential difference between the counter electrode and the working electrode of a cell where there is no current flow and the electrode potentials are at equilibrium, and the state of charge (SOC) of the battery, meaning the remaining capacity of the battery. The voltage profile on discharge can be determined by discharging a charged cell from 100% state of charge to 0% state of charge and determining the OCV of the battery during the discharge process. Similarly, the voltage profile on charge can be determined by charging a discharged cell from a discharged state (0% state of charge) to a fully charged state (100% state of charge) and determining the OCV of the battery during the charging process. Plotting OCV versus state of charge provides the voltage profile. Even where the chemistry of two connected batteries is identical, the voltage profiles on discharge and charge will not be identical due to unavoidable loss of energy as infrared radiation, but a similarity of within 0.01 volts, preferably within 0.005 volts, further preferably within 0.001 volts allows an efficient transfer of charge. Accordingly, symmetrical voltage profiles within this threshold can be treated as the same.

FIG. 2 shows a more detailed block diagram of the controller [15] in the Charger [11]. It comprises a system controller [21], power conditioning system [22], and battery management system (BMS) [23]. As shown in FIG. 1a, the controller [15] is connected to the internal battery [13] of the Charger [11]. The Charger [11] further comprises a charging engine [24], which is connected to the internal battery [13] and controls the outgoing power to maximise discharge speed and therefore charging speed of the battery [14] of the Receiver [12]. The Charger [11] is connected to a Receiver [12] as shown in FIG. 1a.

Of the engines in the controller [15], the system controller [21] controls and receives instructions from any user interface and carries out instructions such as beginning and ending charging and discharging sessions. It may also log session data for system diagnostics, control system-wide resources such as thermal control and communications, and control the interactions of other engines and systems within the Charger [11]. For example, it communicates with the power conditioning system [22] to manage charge current level and mode of operation. For example, where the power conditioning system [22] contains a buck-boost converter the system controller [21] may control whether the current is increased or decreased.

Accordingly, the power conditioning system [22] acts as a controllable current source for charging and discharging of the internal battery [13] and may incorporate a boost, buck, or buck-boost circuit for this purpose. It may operate in a bypass mode during charging of the battery [13] and operate for power conditioning during discharge to take account of the requirements of a connected Receiver [12] or Carrier [18]. As previously mentioned, it may be connected to the system controller [21] to receive instructions, manage the charging session, and report real-time diagnostic information.

The BMS [23] monitors the cells that comprise the internal battery [13] to obtain real-time diagnostic information on any or all of cell voltage and temperature, isolation resistance, bus voltage and current, state of charge, state of health, balancing, and power availability. It may also or instead perform coulomb counting, balancing control, fault and safety management, and contactor control and sequencing.

A similar system may also be provided in the controller of the Carrier [18], which also requires control when operating in charging mode. It is likely that the controller [16] of the Receiver [12] will comprise the BMS [23] and none of the other engines [21, 22], but it may also have a power conditioning system [22] to control the charging current and/or a system controller [21], especially where there is a user interface or other engines in the Receiver [12] that require control or information input. This function may be carried out by other controllers or engines in the device acting as a Receiver [12], depending on its complexity.

FIGS. 3a and 3b show example detailed views of the engines shown in FIG. 2. Of these, FIG. 3a shows detailed views of the charging engine [24] and system controller [21] and shows how they are interconnected for signalling, together with their connections to the battery [13] and power conditioning system [22] FIG. 3b shows detailed views of the power conditioning system [22], BMS [23], and internal battery [13] and shows how they are interconnected for exchanges of power and signals, together with their connections to mains electricity, the charging engine [24] and the system controller [21].

In FIG. 3a, the charging engine [24] comprises a DC-DC charger [31] which provides fast charging to the Receiver [12] and is controlled by power switches in the gate drive [32]. The charging engine [24] is controlled by a power stage controller [33] and fast charge control [34], both of which receive signals from the system controller [21] to optimize charging. The power stage controller [33] further receives voltage, current, and temperature information from the DC-DC charger [31] to maximise the speed of the charging process while avoiding overheating or other possible damage and sends commands to the gate drive [32] accordingly. Together, these engines and controllers control the power transfer between the internal battery [13] of the Charger [11] and the internal battery [14] of the Receiver [12] and enable fast charging.

The system controller [21], as previously mentioned, is connected to a user interface [39] to control it and receive user input as appropriate. The system controller [21] further carries out instructions such as beginning and ending charging and discharging sessions through the charge/discharge session management block [38]; logs session data for system diagnostics through the system diagnostics/data logging block [37], controls system-wide resources such as thermal control and communications through the subsystem monitoring and comms block [36]; and controls the interactions of other engines and systems within the Charger [11] through the subsystem control block [35].

Turning to FIG. 3b, the power conditioning system [22] is, in this example, connected to two potential sources of charge. The first is a conventional 3-phase AC grid input [311], for example for connection to a domestic wall socket. The second is a fast-charging DC direct connection [310] designed for charging battery devices such as a combined charging system ‘Combo 2’ connection as described in standard EN 62196-3 (CCS2 connection). The power conditioning system [22] itself comprises a selection of conversion engines [312] which convert AC power from the three-phase grid connection [311] to DC power which is suitable for charging the battery [13] and further convert DC power between different voltages, for example to provide auxiliary power to run the internal engines of the Charger [11]. The DC fast charger connection [310] is shown to be connected directly to the battery [13]since it is designed for this purpose. There is also a control bus, which receives signals from the system controller [21] to control the conversion engines [311].

The BMS [23] is also connected to the system controller and further to an interface [314] with the battery [13], which, as previously mentioned, is comprised of one or more cells. The BMS [23] carries out balancing of the cells that make up the battery [13] based on voltage, current, and temperature data detected by the interface electronics [314]. The battery [13] is further connected to a protection circuit [315] which contains fuses and acts as a buffer to protect the battery [13] from possible spikes during charging.

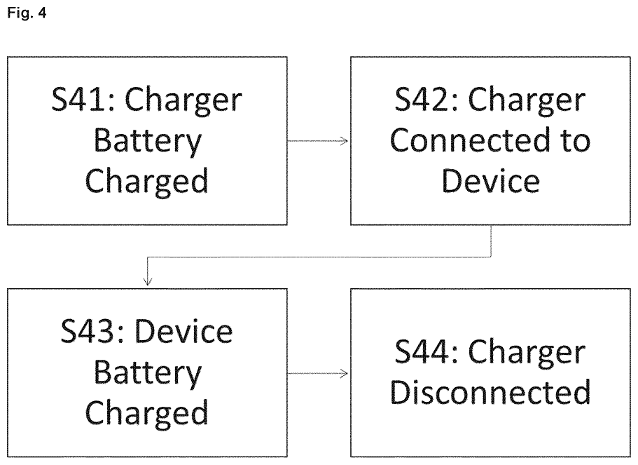

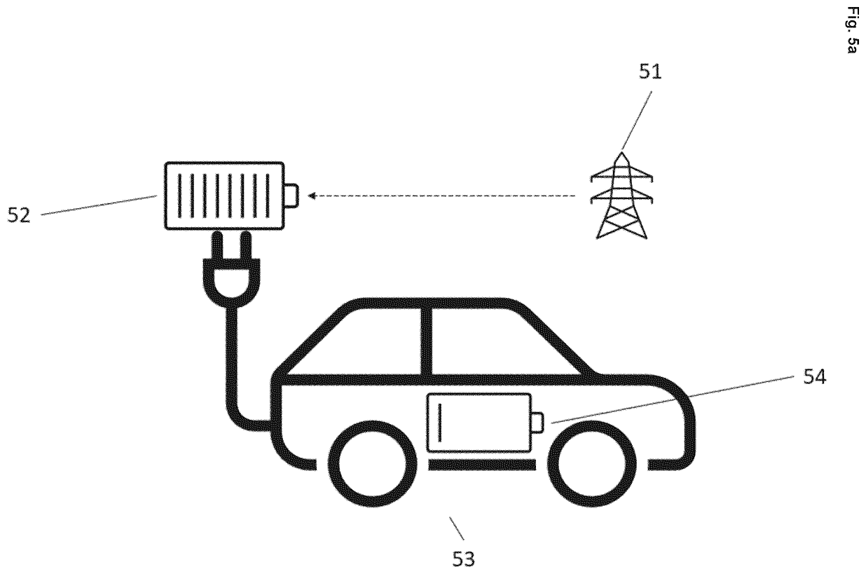

FIG. 4 shows a simplified version of the process which could be carried out when any two of the Charger [11] and Receiver [12], Charger [11] and Carrier [18], or Carrier [18] and Receiver [12] are connected for charging. As previously mentioned, this connection [17] may be via any medium suitable for transferring electrical charge.

For the purposes of this description, the example system used will be an EV charging station which is an example of a Charger [11], connected via a CCS2 connection [17] designed to act as a rapid DC-DC charging connection to an EV which is an example of a Receiver [12] in a system such as that shown in FIG. 1a. Accordingly, hereinafter the reference numbers of FIG. 1a will be used to refer to the charging station (the Charger [11]), EV (the Receiver [12]), and their component parts. However, this is an example only and does not limit the disclosure either in terms of specific utility or number of devices. The parts of the process carried out by the controller [15] of the charging station [11] will be described with reference to FIGS. 2, 3a, and 3b.

At Step S41, the internal battery [13] of the charging station [11] is charged. One of the benefits of the invention is that this can be done at any time, using any method of supplying power, as suggested by the three-phase grid connection [311] and DC fast charge connection [310] shown in FIG. 3b. For example, where the proprietor of the charging station [11] has an electricity supply tariff that supplies power at a lower price overnight when demand is lower, the battery [13] might be charged from mains electricity overnight. Alternatively, the charging station [11] may be equipped with solar panels or a wind turbine which, by their nature, only supply electricity under the right circumstances and in varying amounts. The battery [13] might then be charged when the sun is shining, or the wind is blowing and hold the resulting power until it is required.

As previously mentioned, the charging process is controlled by the system controller [21] and the BMS [23], which determine the nature of the incoming charge and ensure that the battery [13] is charged safely. This may in some circumstances involve activating the power conditioning system [22], for example in slow charging where the current from the source of power is very low and must be boosted to properly charge the battery [13]. Alternatively, the incoming charge may bypass the power conditioning system [22], as mentioned with reference to the DC fast charger connection [310].

At Step S42, the EV [12] is connected to the charging station [11] via the CCS2 connection [17] in the conventional way. The physical connection of the charging cable acts to trigger charging. The system controller [21] in the controller [15] of the charging station [11] determines the maximum C-rate of the EV's internal battery [14] on charging and whether it is capable of fast charging according to the methods of the invention, including comparing the C-rate at which the EV battery [14] is capable of being charged with the C-rate at which the charging station battery [13] is capable of being discharged. This could be done using signals from the controller [16] of the EV [12] across the connection [17]. If the charging C-rate of the EV battery [14] is greater than or equal to the discharge C-rate of the charging station battery [13], the system of the invention can be used. Otherwise, a conventional charging method could be used, possibly involving charging directly from mains power rather than the internal battery [13].

At Step S43, the charging station [11] discharges its internal battery [13] into the battery [14] of the EV [12]. The system controller [21] may activate the power conditioning system [22] to provide the required charging current for the battery [14] of the EV [12], but in the example system shown in FIGS. 3a and 3b the battery [13] is discharged directly through the charging engine [24]. The BMS [23] controls the discharge of the cells that make up the battery [13] of the charging station [11] and the gate drive [32] and other engines within the charging engine [24] control the behaviour of the DC-DC charger [31] to maximise the speed of discharge.

This may involve entirely discharging the battery [13] of the charging station [11] if the battery [14] of the EV [12] and the battery [13] of the charging station [11] have the same capacity and the battery [14] of the EV [12] is fully discharged at the beginning of the process. In other circumstances, for example if the capacity of the battery [13] of the charging station [11] is significantly larger and/or if the battery [14] of the EV [12] does not require a full charge due to its beginning state of charge or user choice, the battery [13] of the charging station [11] may only be partially discharged. The partial discharge may be controlled by the system controller [21] in the charging station [11] based on signals from the battery controller [16] in the EV [12] indicating the state of charge of the EV battery [14] or signals from a user interface [39].

Once the charging is complete, the process moves to Step S44 and the EV [12] is disconnected from the charging station [11]. The system controller [21] then deactivates the power conditioning system [22], if it was used, and the charging engine [24].

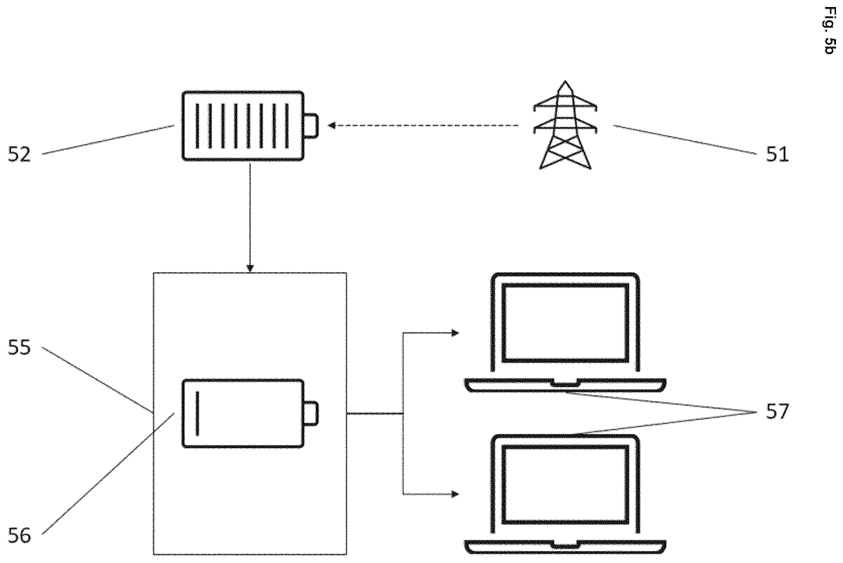

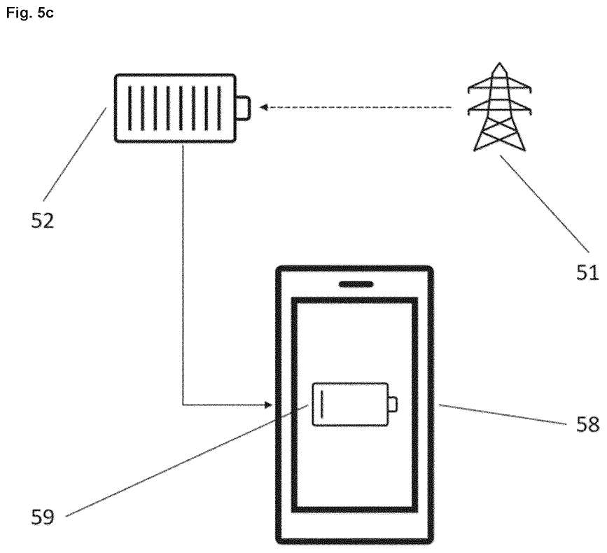

FIG. 5a shows a receiver device, which is an electric vehicle (EV) [53], with a receiver battery [54]. The EV [53] is connected to a charging device [52] containing a battery and controller such that, when the receiver battery [54] is depleted as indicated in FIG. 5a, it can be charged from the battery of the charging device [52], which is shown as being charged to a maximum state of charge (SoC). The charging device [52] is shown as having an optional connection to mains electricity [51] for re-charging the battery of the charging device [52]. The battery of the charging device [52] may only be so connected to mains electricity [51]during the re-charging process. The high input charging rate of the charging device [52] itself means that it can be re-charged in a variety of ways, including by AC charging and DC rapid-charge stations. A DC rapid-charge station is capable of charging at up to 360 kW.

The charging device [52] is operable to both charge and discharge with a power/energy ratio greater than 3, preferably greater than 5, and further preferably greater than 10. It is further operable to carry significantly less charge than the receiver battery [54] of the EV [53] is capable of holding.

The invention allows the battery of the charging device [52] to have a relatively small physical size but a high power density on discharge, resulting in a high discharge rate, typically with a power/energy ratio greater than the charging power/energy ratio of the receiver battery [54] of the EV [53]. However, given that the EV [53] will have a larger battery, it is still able to accept the full power of the charging device [52] and hence has a surprisingly short charging time.

FIG. 5b shows a receiver device which is an uninterrupted power supply (UPS) [55] of a type common in offices and an increasing number of homes, connected to two computing devices [57]. Such UPS devices [55] are commonly used to avoid damage to computing devices such as servers caused by short interruptions to mains power. Most such power cuts last for less than a minute and accordingly many UPS devices [55] are designed to be able to power connected devices [57] for only a short period. Furthermore, many users assume that the UPS [55] will be able to maintain uptime of a connected device [57] and do not act to safely shut down any devices when they realise that mains power has been lost. Accordingly, the internal battery [56] of the UPS [55] may not hold enough charge to maintain a desired output until mains power is resumed.

As described with regard to the EV [53] shown in FIG. 5a, a UPS [55] in a system according to the invention may be further connected to a charging device [52] with an optional connection to mains electricity [51] for charging of its internal battery. As previously described, the charging device [52] is operable to charge and discharge with a high power/energy ratio while carrying less charge than the receiver battery [56] of the UPS [55] can hold. This means that the charging device [52] is capable of discharging into the receiver battery [56] of the UPS [55] at a higher power/energy ratio than the internal battery [56] of the UPS [55] would normally be able to accept. However, since the battery [56] of the UPS [55] is larger than that of the charging device [52] the discharge ratio corresponds to a power/energy ratio that the battery [56] of the UPS [55] can accept in a surprisingly short charging time.

The charging device [52] could alternatively be a secondary emergency system incorporated into the housing of the UPS [55] and activated using a user interface.

FIG. 5c shows a receiver device which is a mobile computing device [58], represented here as a smartphone but this does not limit the example, connected to an emergency charging device [52] similar to those described in FIGS. 5a and 5b. Like those already described, the charging device [52] is capable of charging and discharging at a high power/energy ratio and has an optional connection to mains electricity [51] to allow charging of its internal battery.

The mobile computing device [58] has a receiver battery [59] similar to those described for the EV [53] in FIG. 5a and the UPS [55] in FIG. 5b. The receiver battery [59] is physically smaller with a correspondingly smaller capacity than those described for the EV [53] in FIG. 5a and the UPS [55] in FIG. 5b. In this embodiment, the battery of the charging device [52] is also smaller than those described in FIGS. 5a and 5b, with a correspondingly smaller capacity which, again, is smaller than the receiver battery [59] of the mobile computing device [58].

Despite the reduction in size and capacity compared to the examples previously described, the charging device [52] can charge the receiver battery [59] of the mobile computing device [58] in the same way. The charging device [52] is operable to discharge at a higher power/energy ratio than the receiver battery [59] of the mobile computing device [58] would normally be able to accept, but since it is smaller and is transferring a smaller amount of charge the discharge ratio corresponds to the lower power/energy ratio of the receiver battery [59], resulting in a surprisingly fast charge with a small amount of power, for example enough to finish a conversation, find a conventional charger, or save a document in progress, for example.

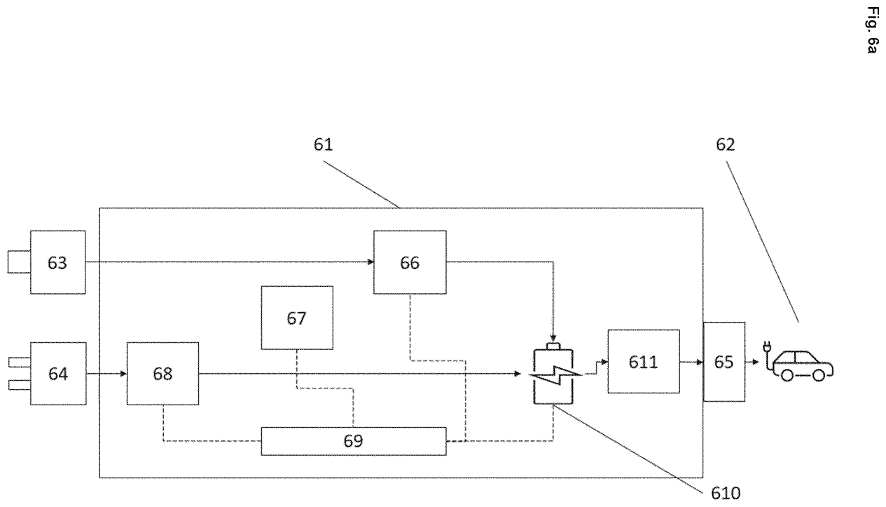

FIG. 6a shows a block diagram of an example charging device [61], comprising two power connectors [63, 64], controllers [67], charging engines [66, 68, 611], and a battery [610] connected to a communication bus [69], and a power connector [65] that can be separably connected to a receiver device, in this example, an EV [62].

Of the power connectors [63, 64], the first [63] is a DC fast charging inlet of the type typically used for charging the batteries of EVs. This provides DC power to the charging device [61] from, for example, a DC fast charging station. DC power can be passed through a power conditioning engine [66]. This charging engine [66] carries out appropriate power conditioning, converting the voltage received from the power connector [63] as appropriate and accordingly may incorporate or be connected to a boost, buck, or buck-boost DC-DC converter in order to carry out power conditioning.

The second power connector [64] is an AC slow charging inlet that could be used to slow charge the charging device [61] from a household power outlet or low-power AC charging station. The power from this input [64] can then be passed through an AC/DC charging engine [68] to charge the battery [610]. The AC/DC charging engine [68] carries out any required conversion and power conditioning.

These types of power connectors [63, 64] are examples only and do not limit the disclosure; other appropriate power inputs could be used, and there may be one or more power connectors. For example, there may be separate input ports for Type 1 and Type 2 charging connectors, which are differently shaped, and they may be connected to the same circuitry within the charging device or have specific charging engines. The DC fast charging power connector [63] could also be arranged to provide AC power from a low-power AC charging station as well as or instead of DC power as described.

The charging device [61] also incorporates a controller [67] which controls the flow of power in and out of the battery [610] in the charging device [61] by determining whether it is to be charged or discharged. It is also capable of signalling to the charging engine [66] to indicate how power conditioning should be carried out and the rate of discharge/charge. Optionally, the controller [67] may further control a user interface, diagnostics, fault protection, and other safety and utility features. Alternatively, these may be controlled by specialised processors and/or engines which receive control input and signalling from the controller [67] as appropriate.

The high charge and discharge rate of the charging device [61] are possible due to a combination of the electrochemical properties of the cells that make up the battery [610] and the circuitry comprising the controller [67], the charging engines [66, 68, 611] as will be further described in FIG. 6b. Preferably the cells [21] are arranged such that one or both of anode or cathode comprise a metal oxide, preferably a niobium-based material, niobium oxide, or niobium metal oxide such as niobium tungsten oxide, niobium titanium oxide and/or niobium molybdenum oxide for example, as described in WO 2019/234248, the contents of which are hereby incorporated by reference in their entirety. The battery [610] is also provided with a Battery Management System (BMS) which controls the operation of the battery [610] through functionality such as cell balancing and error detection. The BMS may also be included as part of a charging engine. This is distinct from the system controller [67], which controls the operation of the charging device [61] as a whole.

Although shown in FIG. 6 as a single battery, the battery [610] may comprise any number of electrochemical cells and may be made up of one or more sub-batteries connected to provide power as appropriate. The battery [610] may further be a modular system such that sub-batteries may be removed, replaced, and added as required to maintain and increase the functionality of the charging device [61].

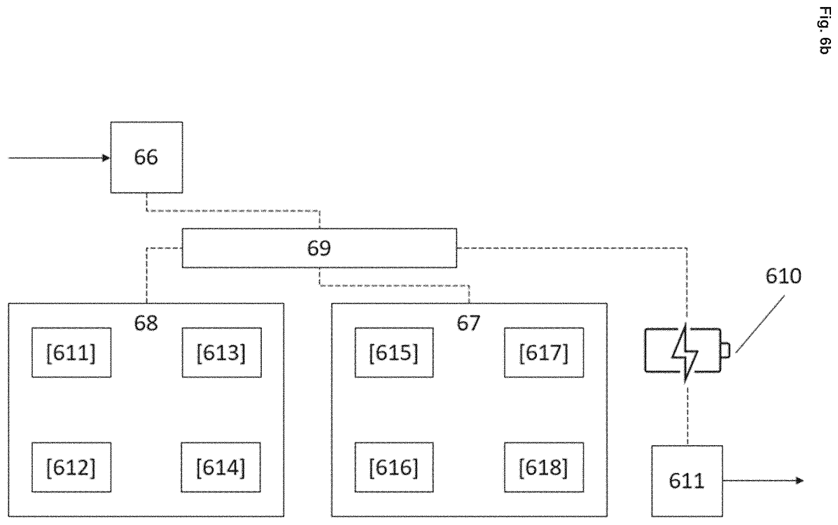

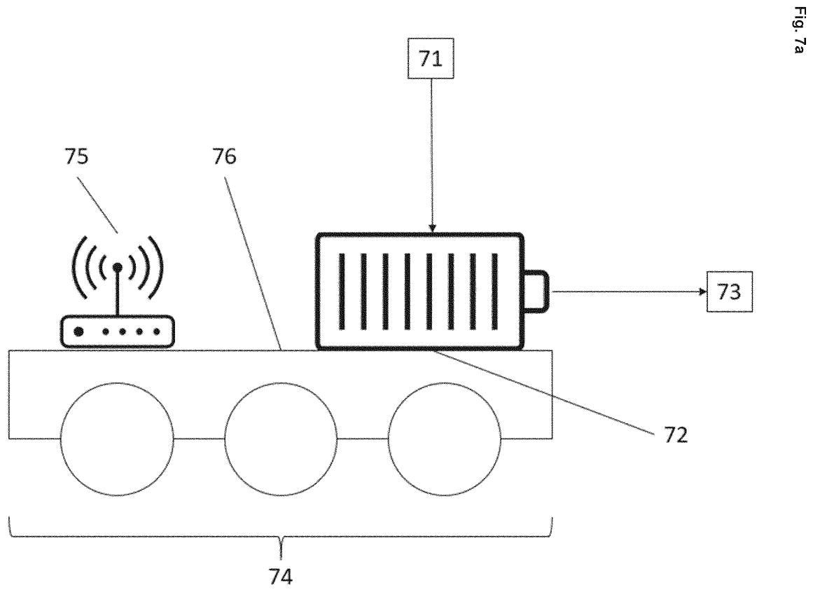

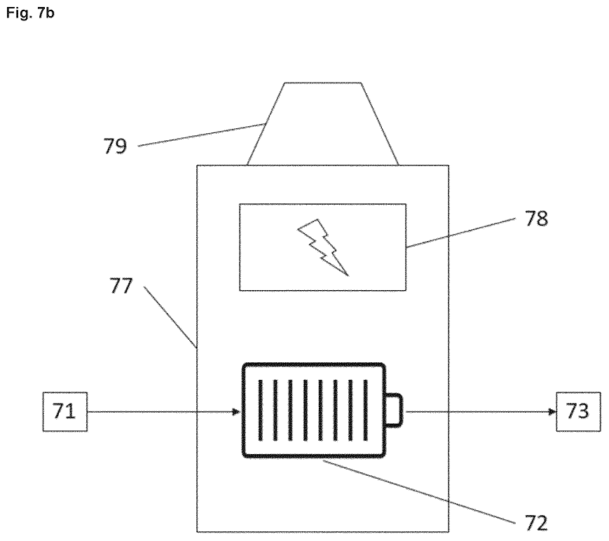

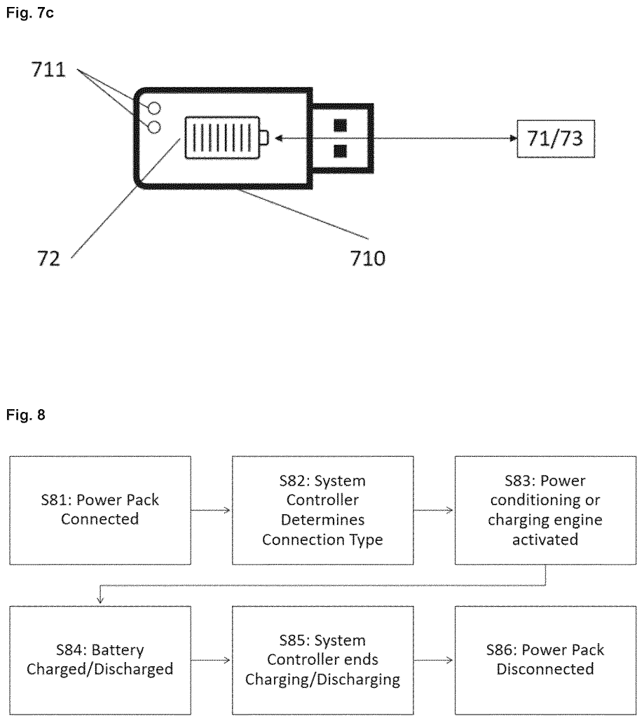

The battery [610] is also connected to the power connector [65] which provides controlled charging to the receiver battery of the receiver device [62]. In the example shown in FIG. 6, the power connector [65] is a separate device to the power connectors [63, 64] and such a configuration is also implied in the example embodiments shown in FIGS. 7a and 7b. However, this is for clarity only and is not binding; the same charging engines [66, 68] as are used for power input might also be used for power output. For example, to limit the size of the charging device [61] and improve user-friendliness it may be beneficial to use the same physical DC fast charging plug [63] for both charging and discharging of the battery [610] of the charging device [61]. In such an embodiment, the connections between the power connector [63], charging engine [66], and battery [610] are bidirectional and the power conditioning circuitry in the charging engine [66] can also be used to carry out required conditioning so that the charging device [61] outputs an appropriate voltage for charging the receiver device [62].

For this purpose, in an embodiment such as the example shown in FIG. 6a where the power connector [63, 64] and charging output [65] are separate, there may also be a charging engine [611] or similar collection of buck, boost, or buck/boost converter circuits together with control circuitry between the battery [610] and the charging output [65] to control the charging of the device [62]. In some embodiments, this functionality may instead be incorporated into the charging output [65].

FIG. 6b shows a more detailed view of the internal controllers.

The AC/DC charging engine [68] first comprises a DC-DC charger [611] which receives power from either the power conditioning engine [66] via the communication bus [69] or directly from the AC power connector [64] via a conversion engine which is not shown in FIG. 6b. It provides fast charging to the battery [610] and is controlled by power switches in the gate drive [612]. The AC/DC charging engine [68] is controlled by a power stage controller [613] and fast charge control [614], both of which receive signals from the system controller [67] to optimize charging. The power stage controller [613] further receives voltage, current, and temperature information from the DC-DC charger [611] to maximise the speed of the charging process while avoiding overheating or other possible damage and sends commands to the gate drive [612] accordingly. This level of fine control allows for the fastest possible charging to be carried out without risking damage to either the engines of the charging device [61] or the cells of the battery [610].

The controller [67] carries out instructions such as beginning and ending charging and discharging sessions through a charge/discharge session management block [618]; logs session data for system diagnostics through a system diagnostics/data logging block [617], controls system-wide resources such as thermal control and communications through a subsystem monitoring and comms block [616]; and controls the interactions of other engines and systems within the charging device [61] through a subsystem control block [615].

As previously mentioned, the battery [610] incorporates a battery management system (BMS), which is connected to the controller via the communication block [69]. The BMS carries out balancing of the cells that make up the battery [610] based on detected voltage, current, and temperature data and may further include a protection circuit containing fuses, which acts as a buffer to protect the battery [610] from possible spikes during rapid charging and discharging.

The charger [611] may contain similar engines to the AC/DC charging engine [68] with similar functionality to receive power from the battery [610] in a controlled manner, which may be based on signalling from the system controller [67], to avoid overheating or other possible damage, carry out any required power conditioning, and output it to the charging output [65].

As with the AC/DC charging engine [68], this combines with the circuitry of the BMS to allow the fastest possible discharge without damaging the charging device [61] or battery [610].

Together, the engines and controllers [66, 67, 68, 611] control the power transfer from the power connectors [63, 64] to the battery [610] and from the battery [610] to the receiver device [62], enabling fast charging and discharging.

FIGS. 7a, 7b, and 7c show three example embodiments of the charging device. The first, shown in FIG. 7a, is a robotic mobile vehicle [74] comprising a wheeled chassis [76] and a remote-control unit or wireless controller [75] which can be used to drive the charging device [74] or give it commands that will cause it to direct itself to a particular location. The wireless controller [75] could also incorporate sensors allowing the mobile unit [74] to navigate around obstacles independently or follow a track such as a painted line. The mobile unit [74] also includes a battery [72] and associated engines such as the ones described in FIG. 6. The battery [72] is capable of being charged as previously described from a power source [71] and of being connected to a receiver device [73] such as an EV and discharged as previously described.

Such a mobile unit [74] could be provided in a car park, industrial site, or other controlled area so that it can be commanded to go to the location of an EV in need of emergency charging. The EV in this example could be a car or other such passenger or goods transportation vehicle or could be a piece of industrial equipment or any other battery-powered device where the receiver battery in the device has a larger capacity than the battery in the charger device. Accordingly, the mobile unit [74] may be an appropriate shape to assist in navigating the area, such as tall and narrow to fit between vehicles or low and flat to fit underneath vehicles where it is used in a car park.

A mobile unit could also travel by a method other than wheels such as caterpillar tracks or may fly using an air cushion or a miniature helicopter system such as those seen on commercially-available drones.

The second embodiment, shown in FIG. 7b, is a manually-operated charging device [77] which could, for example, be carried in a roadside assistance vehicle. A small charging device [77] with a physically small battery [72] could also be carried by the driver of an EV for emergency use. Accordingly, the charging device [77] in this example is provided with a handle [79] for easy transportation and a display panel [78] for providing information on the operation of the charging device [77], for example current SoC of the battery [72]. The display panel [78] could also be a touchscreen for inputting commands.

The manually-operated charging device [77] also incorporates a battery [72] and its associated engines as described in FIG. 6, which can be charged from a power source [71] and discharged to a device [73] as previously described.

The third embodiment, shown in FIG. 7c, is a small form-factor charging device [710] embodied as a USB “thumb drive” with an internal battery [72]. This could, for example, be used in a system such as that shown in FIG. 5c, where the charging device [710/52] is used to transfer a very small amount of charge quickly to a small personal device such as a smartphone [58]. Due to its small size, it cannot have a full user interface such as the one described on the charging device [77] shown in FIG. 7b, but it has two LED lights [711] that can serve as indicators, for example by illuminating a green LED when the charging device [710] is fully charged and operational and a red LED when it is discharged. The thumb drive [710] also contains the battery [72] and associated engines described in FIG. 6 and operates in the same way, though it has a single charging and discharging engine and is charged [71] ad discharged [73] via USB.

FIG. 8 describes the processes followed by a charging device [61] such as that shown in FIG. 6 when connected to be charged itself and when connected to charge the receiver battery of a receiver device such as an EV [62]. The broad outline of the process is the same in both cases, but will be described separately for each: first, the process of charging the battery [610] of the charging device [61] will be described, followed by the process of using the charging device [61] to charge a receiver battery.

At Step S81, one of the power connectors [63/64] of the charging device [61] is connected to a power supply. In the example shown in FIG. 6, this may mean that the DC fast power connector [63] is connected to a DC fast-charging station such as those that are becoming common in public locations such as petrol stations and car parks. Alternatively, it may mean that the AC slow charging power connector [64] is connected to an electrical socket in a building such as a home or garage. In an embodiment such as the one shown in FIG. 7c, other alternative power supplies may be used such as, in this case, a USB socket.

At Step S82, the controller [67] receives a signal from the power connector [63/64] that has been connected to the power supply. This indicates that a connection has been made and allows the controller [67] to determine not only which power connector [63, 64, 65] is being used but also whether the connection was for charging or discharging.

In a device such as that shown in FIG. 6 where the input and output power connections [63, 64, 65] are physically distinct, this could be straightforward to determine as it would be dependent on the connection used. In a device where the same connection is used for both input and output it might be based on the contents of a signal from the connector indicating whether the charging device [61] is connected to a charging station or a device to be charged. The nature of the connection would therefore indicate whether the battery [610] of the charging device [61] is to be charged or discharged. The determination may also include the expected voltage of the power that is being provided and whether it is AC or DC. This information allows the controller [67] to determine what conversions and power conditioning are required.

At Step S83, the controller [67] signals to the power connector [63/64] to begin receiving power and transmitting it to the battery [610]. If the charging is occurring via the DC fast charging inlet [63], the power is received via the charging engine [66], which contains a boost, buck, or buck-boost converter so that the power can be converted to an appropriate voltage for charging the battery [610]. The charging engine [66] is therefore activated and performs appropriate power conditioning.

At Step S84, the battery [610] is charged with the power received from the power connector [63/64] at a rate dependent on the power/energy ratio of the power source, since the battery [610] is capable of being charged at a high rate. When charging is complete and the battery [610] has reached its maximum stored capacity, the BMS ends charging and sends a control signal to the controller [67], which in turn signals the power connector [63/64] to stop receiving power at Step S85. In an embodiment such as that shown in FIG. 7b, it may also carry out other functions such as displaying a message to a user on the display screen [78] to indicate that charging is complete or, in the example shown in FIG. 7c, activate another indicator such as an LED [711].

At Step S86, the charging device [61] is physically disconnected from the source of power and the power connector [63/64] signals the controller [67] to this effect. The controller [67] deactivates any internal mechanisms such as boost, buck, or buck-boost circuitry that were required for charging.

The process will now be described again with reference to charging of a receiving device, such as an EV [62], from the charging device [61]. Although the process is described with reference to an EV [62], this is not intended to be limiting and the same principles could also be applied to the charging of any other device such as a UPS [55] as shown in FIG. 5b or a mobile computing device [58] as shown in FIG. 5c.

At Step S81, the charging device [61] is physically connected to the EV [62] via the charging output [65]. As previously mentioned, this may in some embodiments be the same physical connector as the power connector [63/64], since it may be beneficial to use, for example, the same DC fast charging connector [63] for both charging and discharging of the charging device [61].

At Step S82, the controller [67] determines that the charging device [61] has been connected to a device to be charged [62]. As previously described, this may be through determining that the device [62] has been connected to the charging output [65] or may be via a signal indicating that the receiver device [62] is attempting to draw power.

At Step S83, the controller [67] signals to the charging output [65] that it should begin drawing power from the battery [610] of the charging device [61] via a power conditioning circuit where required to convert the voltage output by the battery [610] to the voltage required by the receiver device [62].

At Step S84, the BMS transmits a signal to the controller [67] indicating that the battery [610] of the charging device [61] has been fully discharged. The controller [67] then signals to the charging output [65] that it should stop drawing power at Step S85, ending discharging of the battery [610]. Where there is a user interface [78], such as that shown in FIG. 7b, the controller [67] could also display an indication on the user interface [78] that the battery [610] has been discharged.

At Step S86, the charging device [61] is physically disconnected from the device [62].

This results in changes to the SoC of the batteries of the power pack [610] and the device [62] such as those shown in FIG. 9, which is based on a simulation of a device such as that shown in FIG. 5a in which a charger with a receiver battery [62] is connected to an EV [53].

FIG. 9 shows a plot of state of charge over time. The estimated state of charge is shown for an example charging device of the invention (solid line) and an EV having a 77 kWh battery capacity charged using the charging device of the invention (dash-dot line). The estimated state of charge is also shown for a comparative example charger device (ZipCharge Go® charger) (dash line) and the same EV charged using the comparative example charger device (dash-dot-dot line).

The charging device transfers power to the EV battery at an average power of 400 kW. At 0 seconds, the example charging device battery is at 100% SoC and the battery of the EV is at 0% SoC. Over the course of 300 seconds (i.e., 5 minutes), the battery of the example charging device discharges to 0% SoC, and the battery of the EV charges to a SoC of 43% (i.e. 33 kWh). The example charging device thus provides 43% of charge in only 5 minutes.

The comparative example charger device (ZipCharge Go® charger) transfers power to the EV battery at an average power of 7.2 kW. At 0 seconds, the comparative example charging device battery is at 100% SoC and the battery of the EV is at 0% SoC. Over the course of 1800 seconds (i.e. 30 minutes), the battery of the comparative example charging device battery discharges to 0% SoC, and the battery of the EV charges to a SoC of about 5% (i.e. 3.6 kWh). The comparative example charging device thus provides 5% of charge in 30 minutes.

The total amount of energy transferred to the EV is significantly higher for the example charging device compared to the comparative example. The rate of charging of the EV is also significantly faster for the example charging device compared to the comparative example.

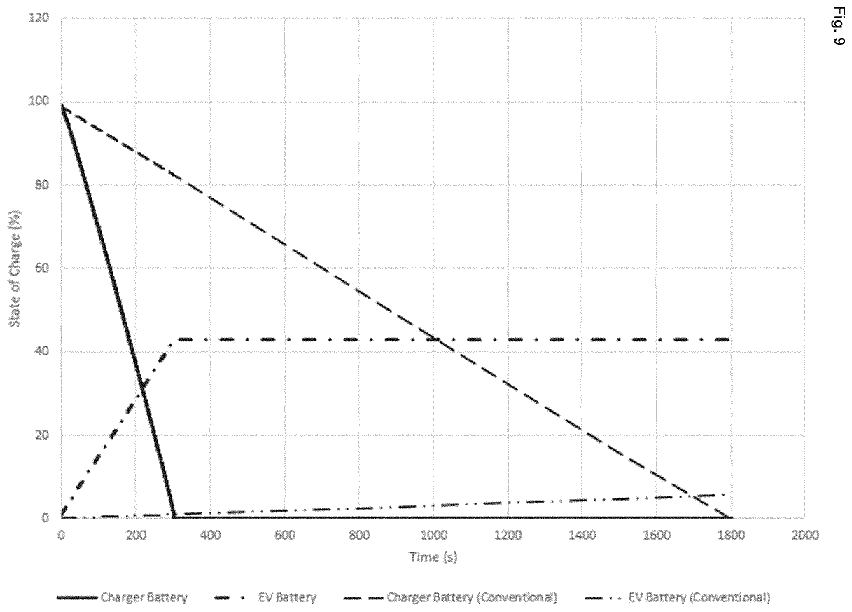

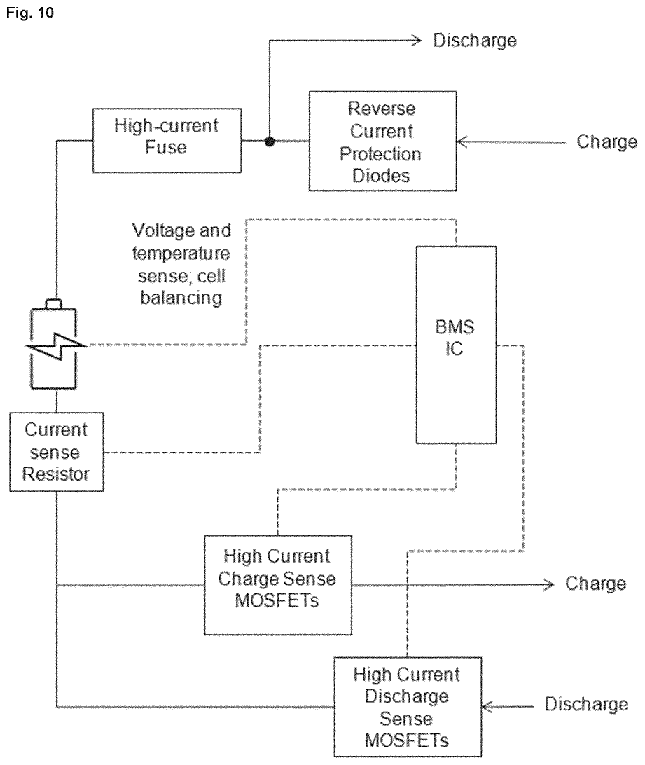

FIG. 10 shows an additional embodiment of the charging device of the invention. In this embodiment, the charging device is configured such that the charge rate of the charger device battery is more than the discharge rate of the charger device battery. This enables the device to have a high uptime, because the time needed to charge the charger device is less than the time over which the device can be discharged to the receiver battery.

FIG. 10 shows a simplified block diagram of a device of the invention, including sensors, protective fuses and diodes, and metal-oxide-semiconductor field-effect transistors (MOSFETs) designed to accept a higher current than standard, together with an integrated circuit (IC) that acts as a controller. In FIG. 10, solid lines indicate connections that carry current during charge and discharge; dashed lines carry signalling data including input from sensors that detect voltage levels, current flow, and temperature of the cells. This sensor data is used to ensure that the cells are not over-charged or over discharged. The battery pack is preferably also equipped with specialised tabs to allow a higher current to avoid the interconnects becoming a bottleneck that could slow charging.

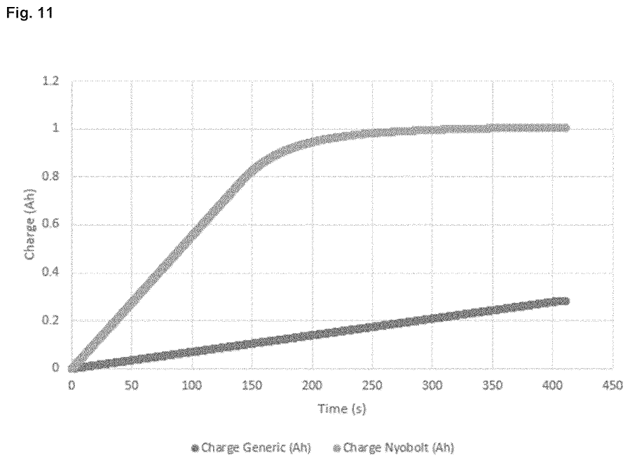

A simulation of the charge rate achievable is shown in FIG. 11. The simulation shows the charge accumulation over time of the charging device shown in FIG. 10 and discussed above, compared to a conventional charging device including a conventional battery. The charging device shown in FIG. 10 is able to charge from 0 Ah to 1 Ah in 250s (about 4 minutes). In contrast, the conventional charging device has a slower charge rate, and so only achieves a charge of about 0.3 Ah in 410s (about over 6 minutes).

The system provides improved current flow and protection of the cells, and enables charging at the cells maximum operable charge rate. As a result, the charger device battery can have a higher charge rate than discharge rate, providing a higher uptime for the device.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

### STATEMENTS OF INVENTION

The following numbered paragraphs contain statements of broad combinations of technical features in accordance with various aspect of the invention disclosed herein.

1. A system comprising:
a charger comprising a first storage device including a first plurality of battery cells operable to discharge at a first C-rate; and
a receiver comprising a second storage device including a second plurality of battery cells, wherein the receiver is operably coupled to the charger and is operable to be charged at a second C-rate by the charger,
wherein the second C-rate is equal to or greater than the first C-rate,
wherein at least one of the first plurality of battery cells or the second plurality of battery cells comprises a working electrode active material comprising a metal oxide.

2. The system of paragraph 1, wherein the working electrode is an anode during a discharge step.

3. The system of paragraph 1 or paragraph 2, wherein a voltage profile of a cell of the first storage device is the same as a voltage profile of a cell of the second storage device.

4. The system of any of paragraphs 1 to 3, further comprising a carrier comprising a third storage device including a third plurality of battery cells,
wherein the carrier is operably coupled to the charger and is operable to be charged at a third C-rate by the charger,
wherein the carrier is operably coupled to the receiver and is operable to discharge at a fourth C-rate to charge the receiver,
wherein the third C-rate is equal to or greater than the first C-rate, and
wherein the second C-rate is equal to or greater than the fourth C-rate.

5. The system of paragraph 4, wherein the fourth C-rate is equal to or greater than the third C-rate.

6. The system of paragraph 4 or paragraph 5, wherein the third plurality of battery cells comprises a working electrode active material comprising a metal oxide.

7. The system of paragraph 6, wherein the working electrode is an anode during a discharge step.

8. The system of any one of paragraphs 1 to 7, wherein the metal oxide is a niobium oxide or niobium metal oxide.

9. The system of paragraph 8, wherein the niobium oxide or niobium metal oxide comprises Nb₂O₅, Nb₂NiO₆, Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, Nb₂W₁₅O₅₀, Nb₂WO₈, Nb₂TiO₇, Nb₁₀Ti₂O₂₉, Nb₂₄TiO₆₂, Nb₂Mo₃O₁₄, Nb₁₄Mo₃O₄₄, Nb₁₂MoO₄₄, Nb₁₁AlO₂₉, Nb₁₁GaO₂₉Nb₄₉GaO₁₂₄, Nb₁₈GeO₄₇, Nb₃₄Cu₂O₈₇, or Nb₃₄Zn₂O₈.

10. The system of any of paragraphs 1 to 9, wherein the charger is configured to charge the receiver in less than 1 minute, wherein the charge comprises charging a cell of the receiver from less than 0.5V to greater than 3V.

11. The system of any of paragraphs 1 to 10, wherein the charger is operable to provide a power density of at least 2 watts per cubic centimetre.

12. The system of any of paragraphs 1 to 11, wherein the charger is a static device.

13. The system of any of paragraphs 1 to 11, wherein the charger is a mobile device.

14. A method of charging a receiver battery from a charging device, the charging device comprising:
a battery, wherein the battery comprises an electrochemical cell,
a power connector, in separable electrical connection with the receiver battery,
a charging engine, in electrical communication with the battery and the power output,
and
a controller, in communication with the battery and the charging engine, and the method comprising the steps of:
discharging the battery to the power connector, using the charging engine,
sending data on the condition of the battery to the controller, and
adjusting the discharge rate of the battery to increase the discharge rate, wherein the discharge rate is increased to a rate of 3C or more, such as 5C or more, 10C or more, or 20 C or more, in response to the data.

15. The method of paragraph 14, wherein the electrochemical cell comprises a working electrode active material comprising a metal oxide, such as a niobium-containing metal oxide.

16. The method of paragraph 14, wherein the electrochemical cell comprises a working electrode active material comprising particles of graphite, Si, SiOₓ (where x is from 0 to 2), or LTO.

17. The method of any of paragraphs 14 to 16, wherein the discharge rate of the battery is increased to a discharge rate which is higher than the charge rate of a receiver battery.

18. The method of any one of paragraphs 14 to 17, wherein data on the condition of the battery is selected from at least one of battery voltage, battery temperature, battery isolation resistance, discharge current, state of charge of the battery, state of balancing of the battery, and power availability of the battery.

19. The method of paragraph 18, wherein data on the condition of the battery comprising battery voltage, battery discharge current, and battery temperature.

20. The method of any of paragraphs 14 to 19, further comprising the steps of:
charging the battery from the power connector, using the charging engine,
sending data on the condition of the battery to the controller, and
adjusting the charge rate of the battery to increase the charge rate, wherein the charge rate is increased to a rate of 3C or more, in response to the data.

21. The method of paragraph 20, wherein the charge rate of the battery is increased to a charge rate of 5C or more, preferably 10C or more, more preferably 20 C or more.

22. The method of paragraphs 20 or 21, wherein charging the battery from the power connector comprises converting the charging power from AC to DC using a converter in the charging engine.

23. The method of paragraphs 14 to 22, wherein discharging the battery to the power connector comprises increasing the discharge voltage using a DC-DC converter in the charging engine, such as a buck, a boost, or a buck-boost converter.

24. The method of any of paragraphs 14 to 23, further comprising the step of:
starting discharging, wherein the controller signals to the charging engine to start or stop discharging the battery, and/or
stopping discharging, wherein the controller signals to the charging engine to stop discharging the battery.

25. The method of paragraph 24, wherein the step of starting and/or stopping discharging is triggered by connection and/or disconnection of a receiving battery and/or power supply to the power connector.

26. The method of any of paragraphs 14 to 25, wherein the step of adjusting the discharge rate of the battery to increase the discharge rate comprises:
(i) determining if the data on the condition of the battery sent to the controller is inside a range, and
(ii) increasing the discharge rate if the data is inside the range, or decreasing the discharge rate if the data is outside the range; and
(iii) repeating steps (i)-(ii) until the controller signals the charging engine to stop discharging the battery.

27. The method of paragraphs 14 to 26 further comprising the steps of:
sending data on the condition of the receiver battery to the controller, and
adjusting the discharge rate of the battery to increase the discharge rate, wherein the discharge rate is increased to a rate of 3C or more, in response to data on the condition of the receiver battery.

28. The method of any of paragraphs 14 to 27, wherein the step of adjusting the discharge rate of the battery to increase the discharge rate comprises independently adjusting the discharge rate of two or more electrochemical cells of the battery, to balance the two or more electrochemical cells of the battery.

29. A charging device, for charging a receiver battery, the charging device comprising:
a battery, wherein the battery comprises an electrochemical cell;
a power connector, to separably electrically connect to the receiver battery;
a charging engine, in electrical communication with the battery and the power connector, wherein the charging engine controls the rate of discharge of the battery; and
a controller, in communication with the battery and the charging engine, for adjusting the discharging rate of the battery in response to data on the condition of the battery, to increase the discharge rate, wherein the discharge rate is increased to a rate of 3C or more.

30. The charging device of paragraph 29, wherein the electrochemical cell comprises a working electrode active material comprising a metal oxide, and the metal oxide is a niobium-containing metal oxide.

31. The charging device of paragraphs 29 or 30 or the method of paragraphs 14 to 28, wherein the working electrode is an anode during discharge.

32. The charging device of paragraphs 31 or the method of paragraph 31, wherein the niobium-containing metal oxide is a lithium niobium oxide, LiNbVO, LiNbLaZrO, LiNbSPO, LiNbAlTiP, LiNbAlGeP, niobium tungsten oxide, titanium niobium oxide, niobium molybdenum oxide, or combinations thereof.

33. The charging device of paragraphs 31 or the method of paragraph 31, wherein the niobium-containing metal oxide is Nb₂O₅, Nb₂NiO₆, Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, Nb₂W₁₅O₅₀, Nb₂WO₈, Nb₂TiO₇, Nb₁₀Ti₂O₂₉, Nb₂₄TiO₆₂, Nb₂Mo₃O₁₄, Nb₁₄Mo₃O₄₄, Nb₁₂MoO₄₄, Nb₁₁AlO₂₉, Nb₁₁GaO₂₉Nb₄₉GaO₁₂₄, Nb₁₈GeO₄₇, Nb₃₄Cu₂O₈₇, or Nb₃₄Zn₂O₈.

34. The charging device of any of paragraphs 29 to 33 or the method of paragraphs 14 to 28 or 31 to 33, wherein the controller comprises a power stage controller.

35. The charging device of any of paragraphs 29 to 34 or the method of paragraphs 14 to 28 or 31 to 34, wherein the power connector comprises a separate power input for charging the battery and power output for discharging the battery.

36. The charging device of any of paragraphs 29 to 35 or the method of paragraphs 14 to 28 or 31 to 35, wherein the power connector comprises a unitary power input for charging the battery and power output for discharging the battery.

37. The charging device of any of paragraphs 28 to 35 or the method of paragraphs 14 to 28 or 31 to 36, wherein the charging engine comprises a gate driver and/or a power conditioner.

38. The use of the charging device of paragraphs 28 to 37 for charging an electric vehicle an uninterrupted power supply or a mobile computing device.

### REFERENCES

A number of publications are cited above in order to more fully describe and disclose the invention and the state of the art to which the invention pertains. Full citations for these references are provided below. The entirety of each of these references is incorporated herein.
WO 2019/234248
WO 2021/074406
WO 2016/205124
US 2020/0070655
GB 2552483
WO 2013/039753
US 2020/0274382.
EP 3026780
EP 2612786
US 2021/0305838
US 2014/0354050
US 2014/0159492
US 2012/0056581
US 2008/0238356

1. A method of charging a receiver battery from a charging device, the charging device comprising:
a battery, wherein the battery comprises an electrochemical cell,
a power connector, in separable electrical connection with the receiver battery,
a charging engine, in electrical communication with the battery and the power output, and
a controller, in communication with the battery and the charging engine, and the method comprising the steps of:
discharging the battery to the power connector, using the charging engine,
sending data on the condition of the battery to the controller, and
adjusting the discharge rate of the battery to increase the discharge rate, wherein the discharge rate is increased to a rate of 3C or more in response to the data.

2. The method of claim 1, wherein the electrochemical cell comprises a working electrode active material comprising a niobium-containing metal oxide.

3. The method of claim 1, wherein the electrochemical cell comprises a working electrode active material comprising particles of graphite, Si, SiOₓ (where x is from 0 to 2), or lithium titanate.

4. The method of claim 1, wherein the discharge rate of the battery is increased to a discharge rate which is higher than the charge rate of a receiver battery.

5. The method of claim 1, wherein data on the condition of the battery is selected from at least one of battery voltage, battery temperature, battery isolation resistance, discharge current, state of charge of the battery, state of balancing of the battery, and power availability of the battery.

6. (canceled)

7. The method of claim 1, further comprising the steps of:
charging the battery from the power connector, using the charging engine,
sending data on the condition of the battery to the controller, and
adjusting the charge rate of the battery to increase the charge rate, wherein the charge rate is increased to a rate of 3C or more, in response to the data.

8. (canceled)

9. The method of claim 7, wherein the charge rate of the battery is increased to a maximum charge rate and the discharge rate of the battery is increased to a maximum discharge rate, wherein the maximum charge rate is greater than the maximum discharge rate.

10. The method of claim 9, wherein the maximum charge rate is 5C or more and the maximum discharge rate is less than 5C.

11. (canceled)

12. The method of claim 1, wherein discharging the battery to the power connector comprises increasing the discharge voltage using a DC-DC converter in the charging engine, wherein the DC-DC converter is a buck, a boost, or a buck-boost converter.

13. The method of claim 1, further comprising the step of:
starting discharging, wherein the controller signals to the charging engine to start or stop discharging the battery, and/or
stopping discharging, wherein the controller signals to the charging engine to stop discharging the battery.

14. (canceled)

15. The method of claim 1, wherein the step of adjusting the discharge rate of the battery to increase the discharge rate comprises:
(i) determining if the data on the condition of the battery sent to the controller is inside a range, and
(ii) increasing the discharge rate if the data is inside the range, or decreasing the discharge rate if the data is outside the range; and
(iii) repeating steps (i)-(ii) until the controller signals the charging engine to stop discharging the battery.

16. The method of claim 1 further comprising the steps of:
sending data on the condition of the receiver battery to the controller, and
adjusting the discharge rate of the battery to increase the discharge rate, wherein the discharge rate is increased to a rate of 3C or more, in response to data on the condition of the receiver battery.

17. The method of claim 1, wherein the step of adjusting the discharge rate of the battery to increase the discharge rate comprises independently adjusting the discharge rate of two or more electrochemical cells of the battery, to balance the two or more electrochemical cells of the battery.

18. A charging device, for charging a receiver battery, the charging device comprising:
a battery, wherein the battery comprises an electrochemical cell;
a power connector, to separably electrically connect to the receiver battery;
a charging engine, in electrical communication with the battery and the power connector, wherein the charging engine controls the rate of discharge of the battery; and
a controller, in communication with the battery and the charging engine, for adjusting the discharging rate of the battery in response to data on the condition of the battery, to increase the discharge rate, wherein the discharge rate is increased to a rate of 3C or more.

19. The charging device of claim 18, wherein the electrochemical cell comprises a working electrode active material comprising a metal oxide, and the metal oxide is a niobium-containing metal oxide.

20. The charging device of claim 18 or the method of any of claims 1 to 17, wherein the working electrode is an anode during discharge.

21. (canceled)

22. The charging device of claim 19, wherein the niobium-containing metal oxide is Nb₂O₅, Nb₂NiO₆, Nb₁₂WO₃₃, Nb₂₆W₄O₇₇, Nb₁₄W₃₀₄₄, Nb₁₆W₅O₅₅, Nb₁₈W₈O₆₉, Nb₂WOs, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, Nb₂W₁₅O₅₀, Nb₂WOs, Nb₂TiO₇, Nb₁₀Ti₂O₂₉, Nb₂₄TiO₆₂, Nb₂Mo₃O₁₄, Nb₁₄Mo₃O₄₄, Nb₁₂MoO₄₄, Nb₁AlO₂₉, Nb₁₁GaO₂₉ Nb₄₉GaO₁₂₄, Nb₁₈GeO₄₇, Nb₃₄Cu₂O₈₇, or Nb₃₄Zn₂O₈.

23. The charging device of claim 18, wherein the charger device battery has an energy density of 100 Wh/L or more.

24. The charging device of claim 18,
wherein the controller comprises a power stage controller.

25. (canceled)

26. (canceled)

27. The charging device of claim 18,
wherein the charging engine comprises a gate driver, a power conditioner, and/or metal-oxide-semiconductor field-effect transistors (MOSFETs).

28. (canceled)
